(19) United States
(12) Patent Application Publication
(10) Pub. No.: US 2012/0215964 A1
(43) Pub. Date: Aug. 23, 2012

(54) MANAGEMENT DEVICE AND MANAGEMENT METHOD

(76) Inventors: Nobuhiro KANEKO, Kanagawa (JP); Shusuke Saeki, Tokyo (JP); Kenji Fudono, Tokyo (JP); Kazunori Yamamoto, Tokyo (JP)

(21) Appl. No.: 13/357,873

(22) Filed: Jan. 25, 2012

(30) Foreign Application Priority Data
Feb. 17, 2011 (JP) 2011-032110

(51) Int. Cl. G06F 12/06; G06F 12/02

(52) U.S. Cl. 711/103; 711/E12.008

(57) ABSTRACT

There is provided a management device including a management unit that manages a nonvolatile memory configured to allow data to be written, read, or erased electrically, allow writing and reading to be performed in units of a page, and allow erasing to be performed in units of a block including a plurality of pages. The management unit divides a plurality of physical blocks of the nonvolatile memory into a virtual area including virtual blocks corresponding to the physical blocks, and an alternate area including alternate blocks for replacing defective physical blocks in the virtual area, manages the nonvolatile memory in management units of three stages including management of the physical blocks, management of the virtual blocks, and management of extended blocks, and writes to the nonvolatile memory first, second, and third management information for use in the management of the physical blocks, the virtual blocks, and the extended blocks, respectively.

### BACKGROUND

The present disclosure relates to a management device and a management method.

In recent years, the capacity of nonvolatile memories to/from which data can be written, read, or erased electrically, such as NAND flash memories, has been increasing. Data writing to the aforementioned nonvolatile memory such as a NAND flash memory is performed by rewriting each bit in a single direction from “1” to “0.” Therefore, in order to write new data to such a nonvolatile memory, writing should be performed after data in the memory is erased once and all bits are set to “1.” In such a nonvolatile memory, the minimum unit of data writing/reading is a “page,” while the minimum unit of erasing is a “block” that is a collection of a plurality of pages.

Against such a background, there has been developed a technology for increasing the efficiency of data writing to a nonvolatile memory. For example, JP 2009-116601A is given as a technology of managing the access to a nonvolatile memory by performing logical address-physical address translation in translation units each being an integer fraction of the block size and an integral multiple of the page size, and copying physical translation units, which are currently used in the block, to another block having unused physical translation units, and then erasing the original block, whereby the number of new, unused physical translation units is increased by the number of invalid physical translation units included in the original block.

### SUMMARY

For example, in the related art for increasing the efficiency of data writing to a nonvolatile memory such as the one described in JP 2009-116601A (hereinafter simply referred to as “related art”), a nonvolatile memory is managed in translation units each being an integer fraction of the block size and an integral multiple of the page size. Further, in the related art, management information, which includes a corresponding logical translation unit number and a sequential number representing the block writing sequence, is written to an extended area of the nonvolatile memory, and based on such management information, a logical address-physical address translation table is constructed to perform management.

Herein, when the related art is used, if the block size in the nonvolatile memory has increased or if the memory capacity of the nonvolatile memory has increased, for example, the volume of the management information will increase correspondingly. Nonvolatile memories such as NAND flash memories have limitations in the number of data rewrite times. Thus, when the written volume of the management information has increased due to an increased volume of the management information, there is a possibility that the lifetime of the nonvolatile memories may be influenced. Accordingly, it is not always the case that the lifetime of nonvolatile memories can be prolonged even when the related art is used.

In light of the foregoing, it is desirable to provide a management device and a management method that are novel and improved and that can manage a nonvolatile memory while prolonging the lifetime of the nonvolatile memory.

According to an embodiment of the present disclosure, there is provided a management device including a management unit that manages a nonvolatile memory, the nonvolatile memory being configured to allow data to be written, read, or erased electrically, allow writing and reading to be performed in units of a page, and allow erasing to be performed in units of a block including a plurality of pages. The management unit divides a plurality of physical blocks that constitute the nonvolatile memory into a virtual area including virtual blocks corresponding to the physical blocks, and an alternate area including alternate blocks for replacing defective physical blocks among the physical blocks included in the virtual area, manages the nonvolatile memory in management units of three stages including management of the physical blocks, management of the virtual blocks, and management of extended blocks, the extended blocks being physical blocks for temporarily storing user data among the physical blocks included in the virtual area, and writes to the nonvolatile memory first management information for use in the management of the physical blocks, second management information for use in the management of the virtual blocks, and third management information for use in the management of the extended blocks.

According to the aforementioned configuration, it is possible to manage a nonvolatile memory while prolonging the lifetime of the nonvolatile memory.

The management unit may, when the virtual area has a single defective physical block, associate a virtual block corresponding to the defective physical block with a single alternate block in the alternate area, and write, as the first management information, information indicating correspondence between the virtual block and the alternate block to the nonvolatile memory, and the management unit may manage the physical blocks using the first management information.

The alternate area may be divided into the alternate blocks and a first management block that is a physical block for storing the first management information. The management unit may, when writing of the first management information to the first management block is complete, set first completion information on the first management block, the first completion information indicating that writing of the first management information is complete.

The management unit may write, as the first management information, information in which an address of the alternate block used is associated with an address of the virtual block corresponding to the alternate block, an address of the alternate block to be allocated the next time a defective block is generated, and an address of the replaced defective block.

The virtual area including the plurality of virtual blocks may be divided into user data blocks that are physical blocks for storing user data, the extended blocks, free blocks that are physical blocks from which data has been erased, and a second management block that is a physical block for storing the second management information, the management unit may manage user data on the basis of logical blocks obtained by dividing an address space of the user data in units of a virtual block size, the management unit may write, as the second management information, first translation information indicating correspondence between the logical blocks and the virtual blocks and information indicating the extended blocks to the second management block, and the management unit may manage the virtual blocks using the second management information.

The management unit may write, as the second management information, the first translation information, addresses of virtual blocks allocated as the extended blocks as the information indicating the extended blocks, addresses of the free blocks, an address of a virtual block to which data is written next, and an address of a virtual block to be erased, the management unit may, when writing of the second management information to the second management block is complete, set second completion information on the second management block, the second completion information indicating that writing of the second management information is complete, and the management unit may, on the basis of the address of the virtual block to be erased in the second management information, erase the corresponding virtual block.

When the management unit writes the second management information while the second management block already has the second management information stored therein, the management unit may write difference information to the second management block, the different information indicating a difference between the stored second management information and the second management information to be newly written.

The extended blocks may be divided into cache blocks that are physical blocks for temporarily storing the user data before the user data are stored into the user data blocks, a first intermediate block that is an intermediate physical block for use in a write-back process that is a process of writing the user data stored in the cache block to the user data block, a second intermediate block that is an intermediate physical block for use in a static wear leveling process, and a third management block that is a physical block for storing the third management information. The management unit may write, as the third management information, second translation information indicating correspondence between the logical blocks and the cache blocks and information indicating each of the cache blocks, the first intermediate block, and the second intermediate block to the third management block, and the management unit may manage the extended blocks using the third management information.

The management unit may divide each of the logical blocks and the cache blocks in translation units each being greater than or equal to the minimum write size of the nonvolatile memory and being less than the virtual block size, and the management unit may further write, as the third management information, third translation information indicating correspondence between the translation units of the logical blocks and the translation units of the cache blocks to the nonvolatile memory.

The management unit may, when writing of the third management information to the third management block is complete, set third completion information on the third management block, the third completion information indicating that the writing of the third management information is complete, the management unit may, on the basis of the second translation information of the third management information, determine if the number of the cache blocks being used has reached a predetermined number, and the management unit may, upon determining that the number of the cache blocks being used has reached a predetermined number, perform a write-back process on user data in a cache block corresponding to a logical block with low update frequency.

The management unit may select a cache block to be subjected to the write-back process using LRU (Least Recently Used) control, or may divide user data to be written in units of a logical block, hold the number of writings performed in each logical block, and select a cache block corresponding to a logical block whose number of writings performed in units of a logical block is the minimum as a cache block to be subjected to the write-back process.

When an error is generated while the management unit is writing data to the extended block, the management unit may hold the data that had been written to the extended block in which the error was generated, the management unit may continuously write data to a corresponding virtual block on the basis of information on the address of the virtual block to which data is written next, the information being recorded in the second management information, and the management unit may perform the write-back process using the data that had been written to the extended block in which the error was generated and the data continuously written to the virtual block.

In the virtual area, the number of physical blocks that constitute the extended blocks may be larger than the number of physical blocks that constitute the user data blocks.

The management unit may write user data to be written to the extended block in order of successive logical addresses.

The management unit may manage the plurality of physical blocks that constitute the nonvolatile memory by dividing the physical blocks into a plurality of virtual areas and a plurality of alternate areas corresponding to the virtual areas, the management unit may, when starting management of the nonvolatile memory, read the second management information stored in a specific virtual area, and the management unit may, on the basis of information recorded in the read second management information, the information indicating a place where the second management information corresponding to each of the other virtual areas is stored, read the second management information corresponding to each of the other virtual areas.

When the management unit starts management of the nonvolatile memory, the management unit may read the first management information, the second management information, and the third management information from the nonvolatile memory, the management unit may determine a writing error by performing each of a determination of a writing error on the basis of the read first management information, a determination of a writing error on the basis of the read second management information, and a determination of a writing error on the basis of the read third management information and a last written page address in the extended block, and the management unit may, upon determining that a writing error has been generated, invalidate the data being processed that corresponds to interrupted writing or erasing, and restore the nonvolatile memory to a state before the process.

The management unit may, when managing a single nonvolatile memory, associate a single virtual block with a plurality of physical blocks, and the management unit may, when managing the same type of a plurality of nonvolatile memories, associate a single virtual block with corresponding physical blocks in the respective nonvolatile memories.

The management device may further include a recording medium to/from which data can be written and read at a faster speed than to/from the nonvolatile memory. The management unit may, when starting management of the nonvolatile memory, read the management information stored in the nonvolatile memory from the nonvolatile memory, and record the read management information on the recording medium, and the management unit may manage the nonvolatile memory on the basis of the management information recorded on the recording medium.

The management device may further include the nonvolatile memory.

According to another embodiment of the present disclosure, there is provided a management method including managing a nonvolatile memory, the nonvolatile memory being configured to allow data to be written, read, or erased electrically, allow writing and reading to be performed in units of a page, and allow erasing to be performed in units of a block including a plurality of pages. The managing step includes dividing a plurality of physical blocks that constitute the nonvolatile memory into a virtual area including virtual blocks corresponding to the physical blocks, and an alternate area including alternate blocks for replacing defective physical blocks among the physical blocks included in the virtual area, managing the nonvolatile memory in management units of three stages including management of the physical blocks, management of the virtual blocks, and management of extended blocks, the extended blocks being physical blocks for temporarily storing user data among the physical blocks included in the virtual area, and writing to the nonvolatile memory first management information for use in the management of the physical blocks, second management information for use in the management of the virtual blocks, and third management information for use in the management of the extended blocks.

When the aforementioned method is used, it is possible to manage a nonvolatile memory while prolonging the lifetime of the nonvolatile memory.

According to the embodiments of the present disclosure described above, it is possible to manage a nonvolatile memory while prolonging the lifetime of the nonvolatile memory.

### BRIEF DESCRIPTION OF THE DRAWINGS

FIG. 1 is an explanatory diagram illustrating the management of a nonvolatile memory by a management device in accordance with an embodiment;

FIG. 2 is an explanatory diagram illustrating the management of a nonvolatile memory by a management device in accordance with an embodiment;

FIG. 3 is an explanatory diagram illustrating an overview of a process related to the management of a nonvolatile memory by a management device in accordance with an embodiment;

FIG. 4 is an explanatory diagram illustrating an example of the management of physical blocks by a management device in accordance with an embodiment;

FIG. 5 is an explanatory diagram showing an example of a first management block in a nonvolatile memory managed by a management device in accordance with an embodiment;

FIG. 6 is an explanatory diagram showing an example of the correspondence between virtual blocks and physical blocks in the management of a nonvolatile memory by a management device in accordance with an embodiment;

FIG. 7 is an explanatory diagram showing an example of the correspondence between virtual blocks and physical blocks in the management of a nonvolatile memory by a management device in accordance with an embodiment;

FIG. 8 is an explanatory diagram illustrating an example of the management of virtual blocks by a management device in accordance with an embodiment;

FIG. 9 is an explanatory diagram showing an example of a second management block in a nonvolatile memory managed by a management device in accordance with an embodiment;

FIG. 10 is an explanatory diagram illustrating another example of the management of virtual blocks by a management device in accordance with an embodiment;

FIG. 11 is an explanatory diagram illustrating an example of the management of extended blocks by a management device in accordance with an embodiment;

FIG. 12 is an explanatory diagram showing an example of associating translation units of a logical block with translation units of a cache block in accordance with an embodiment;

FIG. 13 is an explanatory diagram showing an example of a third management block in a nonvolatile memory managed by a management device in accordance with an embodiment.

FIG. 14 is a flowchart showing an example of a process performed by a management device in accordance with an embodiment at the start of the management of a nonvolatile memory;

FIG. 15 is a flowchart showing another example of a process performed by a management device in accordance with an embodiment at the start of the management of a nonvolatile memory;

FIG. 16 is a flowchart showing an example of a writing process performed by a management device in accordance with this embodiment;

FIG. 17 is a flowchart showing another example of a writing process performed by a management device in accordance with this embodiment;

FIG. 18 is a flowchart showing an example of a write-back process performed by a management device in accordance with an embodiment;

FIG. 19 is a flowchart showing another example of a write-back process performed by a management device in accordance with an embodiment;

FIG. 20 is a flowchart showing still another example of a write-back process performed by a management device in accordance with an embodiment;

FIG. 21 is an explanatory diagram showing another example of associating translation units of a logical block with translation units of a cache block in accordance with an embodiment;

FIG. 22 is a flowchart showing another example of a write-back process performed by a management device in accordance with an embodiment;

FIG. 23 is a flowchart showing an example of an error recovery process performed by a management device in accordance with an embodiment;

FIG. 24 is a flowchart showing another example of an error recovery process performed by a management device in accordance with an embodiment;

FIG. 25 is a block diagram showing a configuration example of a management device in accordance with an embodiment; and

FIG. 26 is an explanatory diagram showing an example of a hardware configuration of a management device in accordance with an embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted by the same reference numerals, and repeated explanation of these structural elements is omitted.

The description will be given in the following order.

1. Management Method in accordance with this Embodiment

2. Management Device in accordance with this Embodiment

3. Program in accordance with this Embodiment

(Management Method in accordance with this Embodiment)

Before describing the configuration of a management device (hereinafter also referred to as a “management device 100”) in accordance with this embodiment, a management method for a nonvolatile memory in accordance with this embodiment will be described. Hereinafter, description will be made on the assumption that the management device 100 performs a process related to the management method in accordance with this embodiment. In addition, hereinafter, an example will be described in which a nonvolatile memory to be managed by the management device 100 in accordance with this embodiment is a NAND flash memory. Note that a nonvolatile memory to be managed by the management device 100 in accordance with this embodiment is not limited to the NAND flash memory. For example, it is also possible to use as a nonvolatile memory to be managed any nonvolatile memory to/from which data can be written, read, or erased electrically and whose write/read size and erase size are different.

[Overview of the Management Method in Accordance with this Embodiment]

When the written volume of management information, which is used for the management of a nonvolatile memory, has increased due to an increased volume of the management information as in the related art as described above, there is a possibility that the lifetime of the nonvolatile memory may be influenced. Further, when the written volume of the management information has increased due to an increased volume of the management information, the time needed for writing the management information to the nonvolatile memory will become longer, which could decrease the performance of data reading, data writing, or data erasing to/from the nonvolatile memory.

Thus, the management device 100 in accordance with this embodiment manages a nonvolatile memory in a plurality of stages, and stores the management information of each management unit into the nonvolatile memory. More specifically, the management device 100 manages a nonvolatile memory in management units of three stages including the management of physical blocks, the management of virtual blocks, and the management of extended blocks, for example. In addition, the management device 100 writes first management information for use in the management of physical blocks, second management information for use in the management of virtual blocks, and third management information for use in the management of extended blocks into the nonvolatile memory, thereby storing the first management information, the second management information, and the third management information (hereinafter also collectively referred to as “management information”) into the nonvolatile memory.

When a nonvolatile memory is managed in a plurality of stages as described above, the size of the management information of each management unit for use in the management in each stage in accordance with this embodiment becomes smaller than the size of the management information in accordance with the related art. Accordingly, the management device 100 can, by storing the management information of each management unit into the nonvolatile memory, reduce the written volume of the management information when storing it into the nonvolatile memory than in the related art, and can further manage the nonvolatile memory using the management information stored therein.

Thus, the management device 100 can manage the nonvolatile memory while prolonging the lifetime of the nonvolatile memory. Further, as the management device 100 can reduce the size of the management information than the size of the management information in accordance with the related art, it is possible to prevent a decrease in performance that could occur when the management information is written using the related art, for example.

Hereinafter, the management method in accordance with this embodiment will be described more specifically. Hereinafter, the management method in accordance with this embodiment will be described with reference to an example in which the management device 100 manages a nonvolatile memory in management units of three stages including the management of physical blocks, the management of virtual blocks, and the management of extended blocks. Note that the management method in accordance with this embodiment is not limited to the method of managing a nonvolatile memory in management units of three stages. For example, the management device 100 can manage a nonvolatile memory in management units of two stages (e.g., including the management of physical blocks and the management of virtual blocks including the management of extended blocks) or four or more stages (e.g., further including the management of free blocks VFB). Even in such cases, the management device 100 can reduce the written volume of the management information when storing it into the nonvolatile memory than in the related art. Further, the management device 100 can also manage the nonvolatile memory using the management information stored therein.

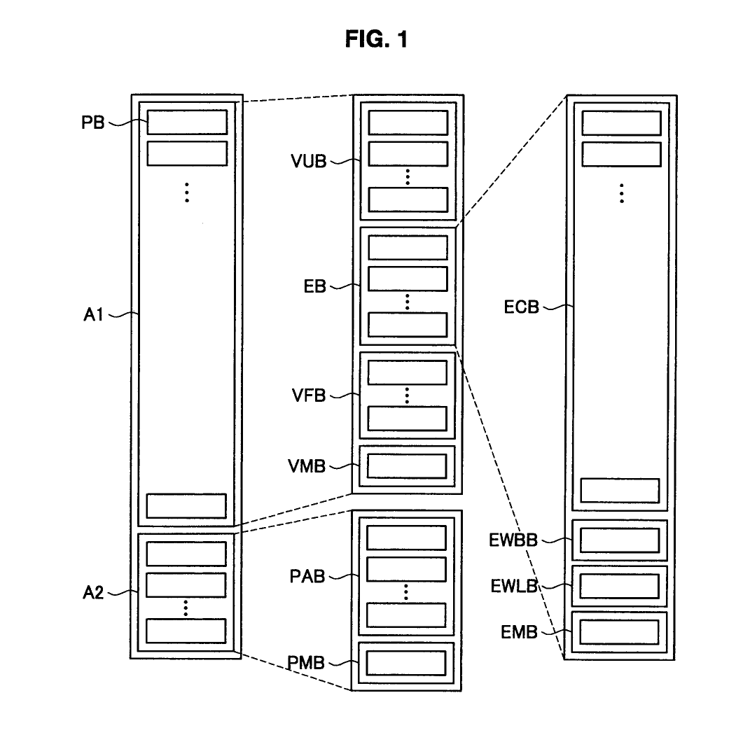

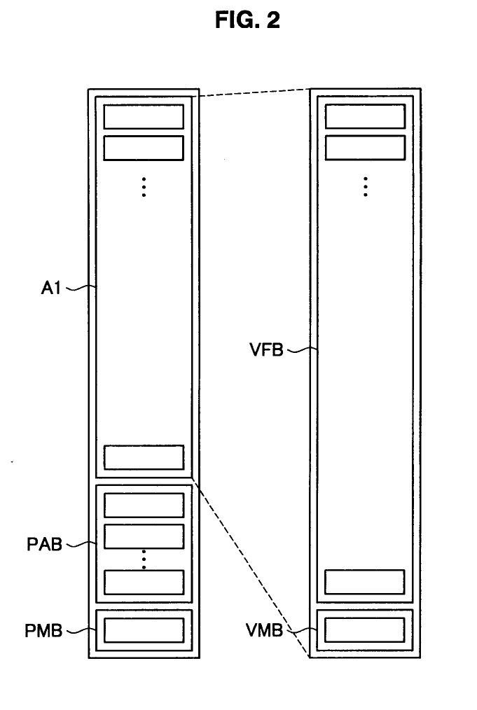

FIGS. 1 and 2 are explanatory diagrams illustrating the management of a nonvolatile memory by the management device 100 in accordance with this embodiment. Herein, FIG. 1 shows an example of the state of a nonvolatile memory when data to be stored in the nonvolatile memory (hereinafter referred to as “user data”), such as content data indicating an image (a moving image/a still image) or sound (including music), text data, or application data, is written to the nonvolatile memory. FIG. 2 shows the initial state of the nonvolatile memory with no user data written therein.

As shown in FIG. 1, the nonvolatile memory includes a plurality of physical blocks PB. The management device 100 divides the nonvolatile memory into a virtual area A1 and an alternate area A2. Herein, the alternate area A2 is an area including alternate blocks for replacing physical blocks having defects (hereinafter referred to as “defective blocks”) among the physical blocks included in the virtual area A1. A replacement process in accordance with this embodiment is described below.

Hereinafter, physical blocks included in the virtual area A1 may also be referred to as “virtual blocks” (or “VB”). Note that each virtual block in accordance with this embodiment and each physical block PB that constitutes the virtual area A1 can have either one-to-one correspondence or one-to-plural correspondence. That is, the size of each virtual block in accordance with this embodiment can be either identical to or an integral multiple of the size of each physical block PB. Hereinafter, an example in which each virtual block and each physical block PB have one-to-one correspondence will be mainly described.

First, the virtual area A1 will be described. The virtual area A1 is divided into user data blocks VUB, extended blocks EB, free blocks VFB, and a second management block VMB. Herein, the user data blocks VUB are physical blocks for storing user data, and the total size of the user data blocks VUB indicates the size of data that can be written by a user, for example. The extended blocks EB are physical blocks for temporarily storing user data. The free blocks VFB are physical blocks from which data has been erased (i.e., physical blocks with no data written therein). The second management block VMB is a physical block for storing the second management information.

Although FIG. 1 shows a configuration in which each of the user data blocks VUB and the extended blocks EB include a plurality of physical blocks, physical blocks that constitute each of the user data blocks VUB and the extended blocks EB can be recognized as user data blocks VUB and extended blocks EB. In addition, the free blocks VFB shown in FIG. 1 can be considered in a similar way to the user data blocks VUB and the extended blocks EB shown in FIG. 1.

The number of the physical blocks PB that constitute the user data blocks VUB and the number of the physical blocks PB that constitute the extended blocks EB are set by the management device 100, for example. Herein, the management device 100 sets each of the number of the physical blocks PB related to the user data blocks VUB and the number of the physical blocks PB related to the extended blocks EB to a predetermined number, but the process of the management device 100 is not limited thereto. For example, the management device 100 can set (or reset) the number of physical blocks PB related to the user data blocks VUB and the number of the physical blocks PB related to the extended blocks EB on the basis of an operation signal corresponding to a user operation transmitted from an operation unit (described below) or an external operation signal corresponding to a user operation transmitted from an external operation device such as a remote controller.

Herein, if the number of the physical blocks PB that constitute the extended blocks EB is set larger than the number of the physical blocks PB that constitute the user data blocks VUB, the management device 100 can reduce the frequency of write-back processes and the rewriting frequency of the nonvolatile memory. Accordingly, as the management device 100 can prolong the lifetime of the nonvolatile memory in the aforementioned case, it is also possible to prolong a period for which a memory system including the nonvolatile memory to be managed can be used. In addition, by reducing the rewriting frequency of the nonvolatile memory, the management device 100 can suppress a decrease in performance of the nonvolatile memory such as a decrease in speed that could occur in execution of a rewriting process.

The extended blocks EB are divided into cache blocks ECB, a write-back block EWBB (a first intermediate block), a wear-leveling block EWLB (a second intermediate block), and a third management block EMB. Herein, the cache blocks ECB are physical blocks for temporarily storing user data before they are stored into the user data blocks VUB. The write-back block EWBB is an intermediate physical block for use in a write-back process that is a process of writing user data stored in the cache block ECB to the user data block VUB. The wear leveling block EWLB is an intermediate physical block for use in a static wear leveling process. The third management block EMB is a physical block for storing the third management information.

The virtual area A1 has the aforementioned configuration, for example. Next, the alternate area A2 will be described.

The alternate area A2 is divided into alternate blocks PAB used for a replacement process (described below) and a first management block PMB that is a physical block for storing the first management information.

The management device 100 manages the nonvolatile memory to be managed by managing the physical blocks PB, the virtual blocks, and the extended blocks EB with the configurations shown in FIG. 1, for example.

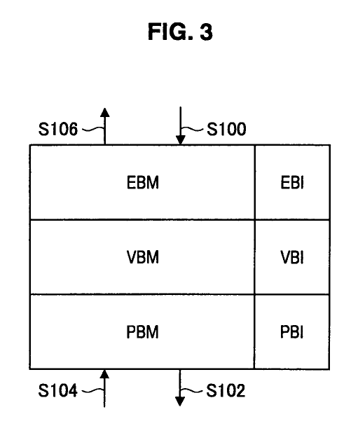

Next, an overview of a process related to the management of a nonvolatile memory by the management device 100 will be described. FIG. 3 is an explanatory diagram illustrating an overview of a process related to the management of a nonvolatile memory by the management device 100 in accordance with this embodiment. Herein, FIG. 3 shows an example of the configuration of software for controlling the management of a nonvolatile memory.

### (i) Writing Process

An extended block management layer (hereinafter referred to as an “EBM layer”) receives a write instruction and data transmitted from a file system or an application that is being executed, for example (S100). The EBM layer refers to the third management information (hereinafter also referred to as “EBI”), and transmits the write instruction to a virtual block management layer (hereinafter referred to as a “VBM layer”).

Upon receiving the write instruction, the VBM layer refers to the second management information (hereinafter also referred to as “VBI”) and transmits the write instruction to a physical block management layer (hereinafter referred to as a “PBM layer”).

Upon receiving the write instruction, the PBM layer refers to the first management information (hereinafter also referred to as “PBI”) and writes the data to the physical block PB in the nonvolatile memory (S102).

Upon receiving a response from the nonvolatile memory in accordance with the writing process (S104), the PBM layer transmits the response to the VBM layer. In addition, the VBM layer transmits the received response to the EBM layer. Then, the EBM layer transmits the received response to the file system, the application, or the like that has transmitted the write instruction (S106).

In the management device 100, data is written to a nonvolatile memory in response to a write instruction through the aforementioned process, for example.

### (ii) Reading Process

The EBM layer receives a read instruction transmitted from a file system or an application that is being executed, for example (S100). The EBM layer refers to the third management information and transmits the read instruction to the “VBM layer.”

Upon receiving the read instruction, the VBM layer refers to the second management information and transmits the read instruction to the PBM layer.

Upon receiving the read instruction, the PBM layer refers to the first management information and transmits the read instruction to the nonvolatile memory (S102).

Upon receiving a response indicating the completion of reading and data corresponding to the read instruction from the nonvolatile memory (S104), the PBM layer transmits the response and the data to the VBM layer. In addition, the VBM layer transmits the received response and data to the EBM layer. Then, the EBM layer transmits the received response and data to the file system, the application, or the like that has transmitted the read instruction (S106).

In the management device 100, data is read from a nonvolatile memory in response to a read instruction through the aforementioned process, for example.

In the management device 100, data writing to a nonvolatile memory or data reading from the nonvolatile memory is performed via the three layers including the EBM layer, the VBM, and the PBM layer as shown in FIG. 3, for example.

Next, each of the management of physical blocks, the management of virtual blocks, and the management of extended blocks in accordance with this embodiment will be described more specifically.

### (I) Example of the Management of Physical Blocks

The management device 100, when a physical block PB associated with a virtual block is a defective block, replaces the defective block with an alternate block in the alternate area A2, using the first management information. In addition, the management device 100 associates the virtual block corresponding to the defective block with the alternate block that has replaced the defective block, and writes information indicating the correspondence between the virtual block and the alternate block into the nonvolatile memory as the first management information. Then, the management device 100 manages the physical block using the first management information. Herein, the defective block can be either the one generated during the manufacture of the nonvolatile memory or the one that has become a defective block thereafter.

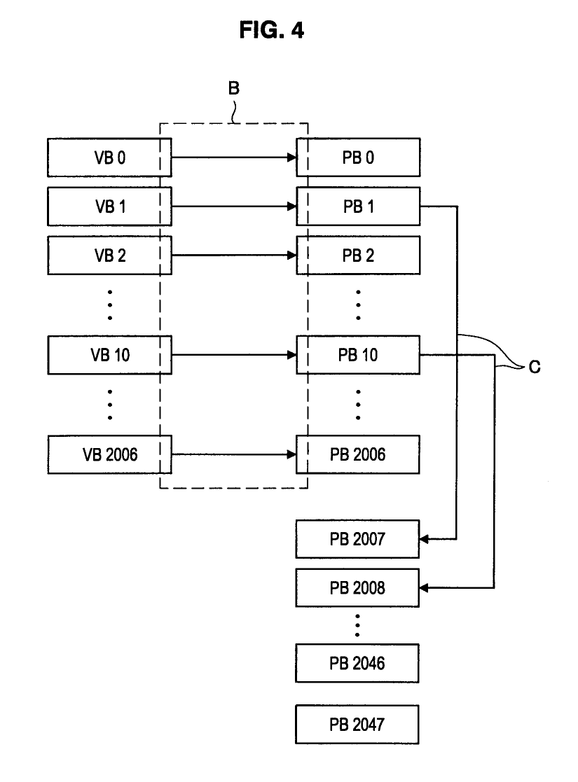

FIG. 4 is an explanatory diagram illustrating an example of the management of physical blocks by the management device 100 in accordance with this embodiment. In FIG. 4, an example is shown in which each virtual block and each physical block have one-to-one correspondence as indicated by symbol B in FIG. 4.

When a physical block PB 1 and a physical block PB 10 shown in FIG. 4 are defective blocks, for example, the management device 100 replaces the physical block PB 1 and the physical block PB 10 with alternate blocks (a physical block PB 2007 and a physical block PB 2008 in the example of FIG. 4), respectively. Then, the management device 100 writes information indicating the correspondence between the defective blocks and the alternate blocks that have replaced the defective blocks into the first management block PMB as the first management information.

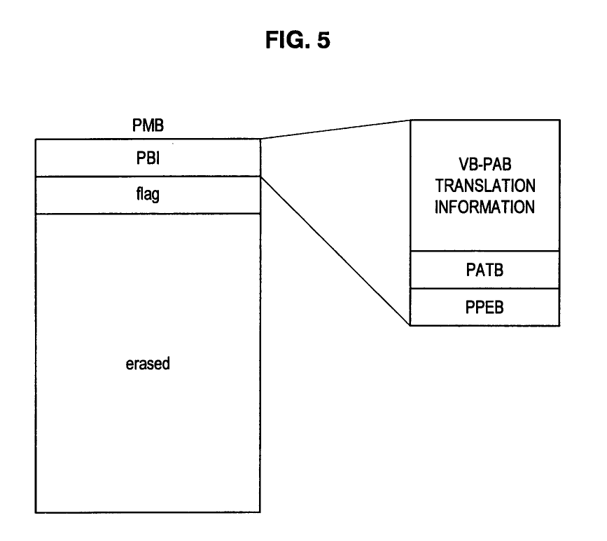

FIG. 5 is an explanatory diagram showing an example of the first management block PMB in the nonvolatile memory managed by the management device 100 in accordance with this embodiment. In FIG. 5, an example of the first management information in accordance with this embodiment is also shown.

In the first management block PMB, the first management information and first completion information, which indicates that writing of the first management information is complete, are stored, for example. Although FIG. 5 shows an example in which the first completion information is a flag indicating if writing of the first completion information is complete, it is needless to mention that the first completion information in accordance with this embodiment is not limited to the flag. Hereinafter, a flag indicating if writing of the first completion information (or a second completion flag or a third completion flag described below) is complete may also be referred to as a “write completion flag.”

The first management information in accordance with this embodiment includes, for example, translation information between virtual blocks VB and alternate blocks PAB, information on an alternate block (hereinafter also referred to as “PATB”) to be allocated the next time a defective block is generated, and information on a replaced defective block (hereinafter also referred to as “PPEB”).

Hereinafter, the translation information between virtual blocks VB and alternate blocks PAB corresponds to the aforementioned information indicating the correspondence between the defective blocks and the alternate blocks that have replaced the defective blocks. The translation information between virtual blocks VB and alternate blocks PAB can be, for example, a table in which the virtual blocks VB are associated with the alternate blocks PAB or information in which the addresses of the alternate blocks used are associated with the addresses of the virtual blocks corresponding to the alternate blocks. The PATB can be, for example, the address of an alternate block to be allocated the next time a defective block is generated. The PPEB can be, for example, the address of the replaced defective block.

The management device 100, when updating the first management information after performing a replacement process such as the one shown in FIG. 4, for example (or when newly generating the first management information), writes the first management information to the first management block PMB. Then, the management device 100, when writing of the first management information to the first management block PMB is complete, sets the first completion information, which indicates that writing of the first management information is complete, on the first management block PMB. For example, in the example of FIG. 5, the management device 100, when writing of the first management information to the first management block PMB is complete, sets the flag to a value indicating that the writing is complete.

The management device 100 manages the physical blocks through the aforementioned process, for example. Note that the management of the physical blocks by the management device 100 in accordance with this embodiment is not limited to the aforementioned example. For example, although FIG. 4 shows an example in which each virtual block and each physical block have one-to-one correspondence, the management device 100 can manage the nonvolatile memory by associating each virtual block with a plurality of physical blocks.

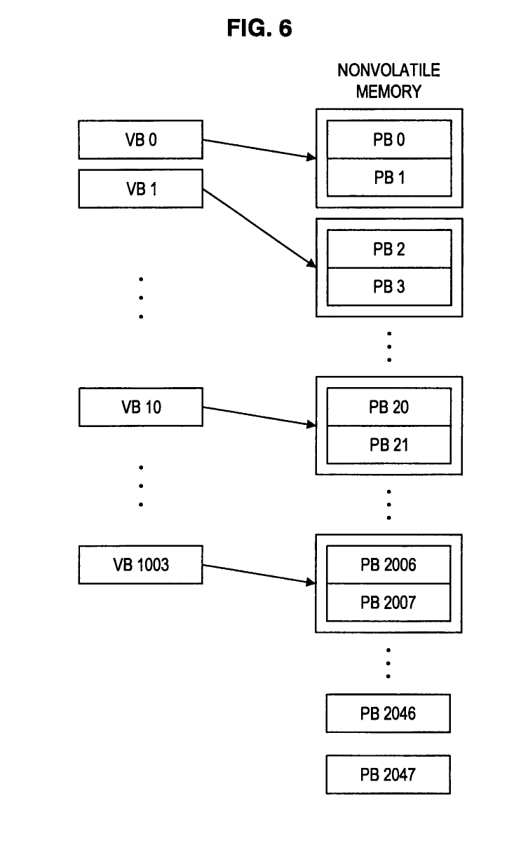

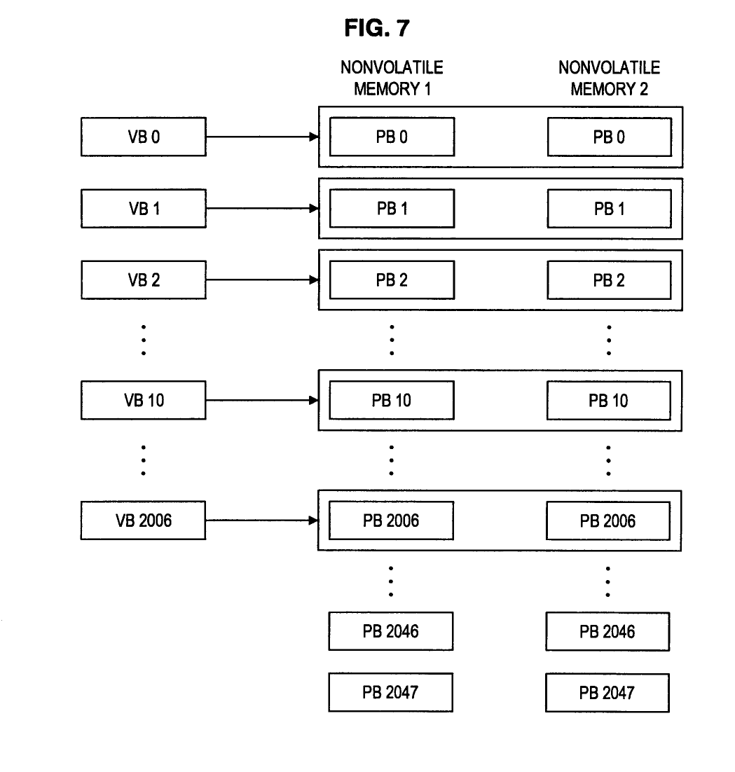

FIGS. 6 and 7 are explanatory diagrams each showing an example of the correspondence between virtual blocks and physical blocks in the management of a nonvolatile memory by the management device 100 in accordance with this embodiment. Herein, FIG. 6 shows an example of the correspondence between virtual blocks and physical blocks when the management device 100 manages a single nonvolatile memory. FIG. 7 shows an example of the correspondence between virtual blocks and physical blocks when the management device 100 manages a plurality of nonvolatile memories. Herein, the plurality of nonvolatile memories can be the same type of nonvolatile memories, for example.

As shown in FIG. 6, when managing a single nonvolatile memory, the management device 100 associates a single virtual block with a plurality of physical blocks. More specifically, the management device 100 associates physical blocks with successive addresses or a plurality of physical blocks, which have been uniquely determined through a computation process, with a virtual block, for example. Although FIG. 6 shows an example in which a single virtual block is associated with two physical blocks, it is needless to mention that the management device 100 can associate a single virtual block with three or more physical blocks.

Meanwhile, when managing a plurality of nonvolatile memories as shown in FIG. 7, the management device 100 associates a single virtual block with corresponding physical blocks in the respective nonvolatile memories. That is, the management device 100 manages the plurality of nonvolatile memories in parallel.

When a single virtual block is associated with a plurality of physical blocks as shown in FIGS. 6 and 7, the size (block size) of each virtual block becomes larger than when a single virtual block is associated with a single physical block. When the size of each virtual block becomes larger, the size of each extended block ECB in the nonvolatile memory also becomes larger than when a single virtual block is associated with a single physical block. Accordingly, the management device 100 can increase the volume of data that can be written to the extended block ECB, and thus can reduce the frequency of write-back processes and the rewriting frequency of the nonvolatile memory. Thus, as the management device 100 can prolong the lifetime of the nonvolatile memory, it is also possible to prolong a period for which a memory system including the nonvolatile memory to be managed can be used. Further, by reducing the rewriting frequency of the nonvolatile memory, the management device 100 can suppress a decrease in performance of the nonvolatile memory such as a decrease in speed that could occur in execution of a rewriting process.

### (II) Example of the Management of Virtual Blocks

Next, an example of the management of virtual blocks in accordance with this embodiment will be described. The management device 100 manages user data on the basis of logical blocks (hereinafter also referred to as “LBs”) obtained by dividing the address space of the user data in units of the virtual block size. In addition, the management device 100 writes first translation information, which indicates the correspondence between logical blocks and virtual blocks, and information indicating the extended blocks into the nonvolatile memory as the second management information. Then, the management device 100 manages the virtual blocks using the second management information.

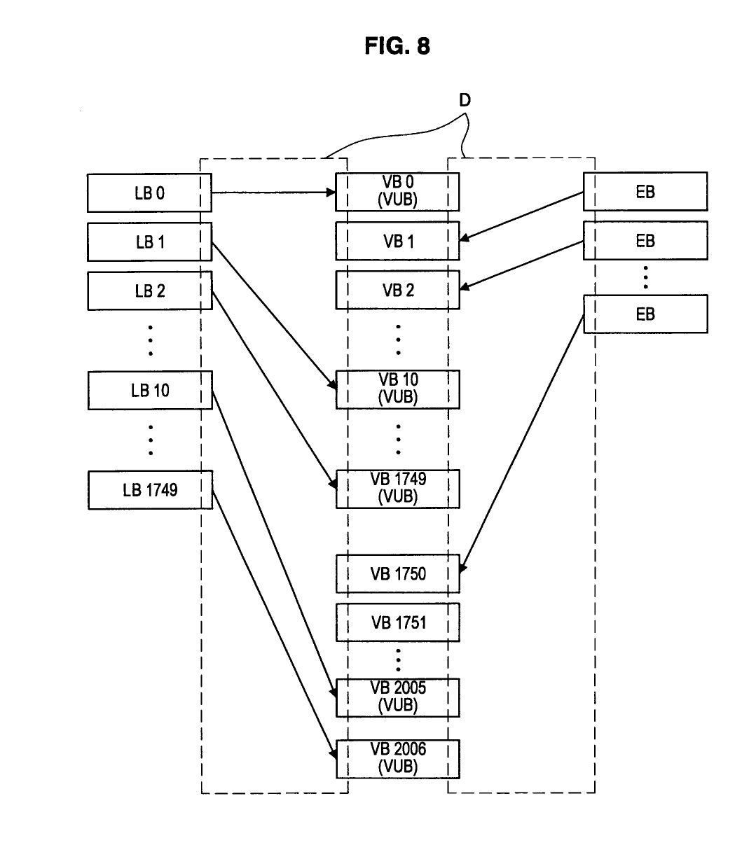

FIG. 8 is an explanatory diagram illustrating an example of the management of virtual blocks by the management device 100 in accordance with this embodiment.

The management device 100, using the second management information, manages the correspondence between logical blocks and virtual blocks and also manages which virtual block is an extended block as indicated by symbol D in FIG. 8.

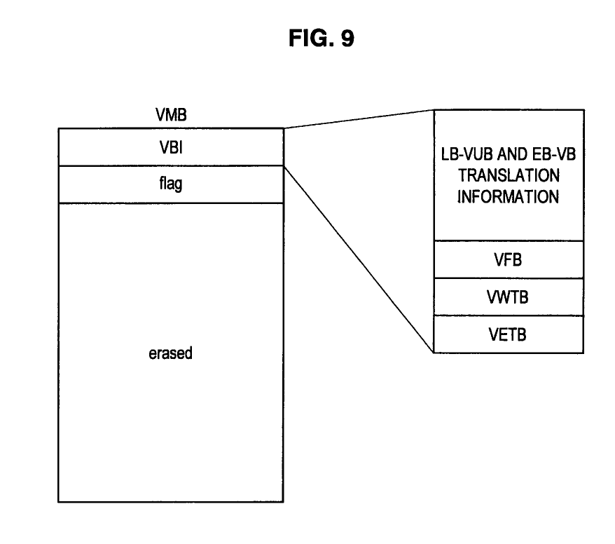

FIG. 9 is an explanatory diagram showing an example of the second management block VMB in the nonvolatile memory managed by the management device 100 in accordance with this embodiment. In FIG. 9, an example of the second management information in accordance with this embodiment is also shown.

In the second management block VMB, the second management information and second completion information indicating that writing of the second management information is complete are stored, for example. Although FIG. 9 shows an example in which the second completion information is a flag indicating if writing of the second completion information is complete, it is needless to mention that the second completion information in accordance with this embodiment is not limited to the flag.

The second management information in accordance with this embodiment includes, for example, translation information between logical blocks and user blocks, translation information between extended blocks and virtual blocks, information indicating free blocks VFB, information on a virtual block to which data is to be written next (hereinafter also referred to as “VWTB”), and information on a virtual block to be erased (hereinafter also referred to as “VETB”).

Herein, the translation information between logical blocks and user blocks corresponds to the aforementioned first translation information. The translation information between logical blocks and user blocks can be, for example, a table in which the logical blocks are associated with the user blocks or information in which the addresses of the logical blocks are associated with the addresses of the user blocks. The translation information between extended blocks and virtual blocks corresponds to the aforementioned information indicating the extended blocks. The translation information between extended blocks and virtual blocks can be, for example, the addresses of virtual blocks allocated as extended blocks. The VWTB can be, for example, the address of a free block. The VETB can be, for example, the address of a virtual address to be erased.

The management device 100 can perform management of user data on the basis of logical blocks, management of the correspondence between logical blocks and user data blocks, management of virtual blocks allocated as extended blocks, management of free blocks (unused virtual blocks), management of the VWTB, and management of the VETB by using the second management information with the structure shown in FIG. 9, for example. Note that it is needless to mention that the second management information in accordance with this embodiment is not limited to the structure shown in FIG. 9.

The management device 100, when writing (newly writing or updating) user data, writes the data to a virtual block indicated by the VWTB of the second management information, for example, and updates the second management information. Then, the management device 100 writes the second management information to the second management block VMB. In addition, the management device 100, when writing of the second management information to the second management block VMB is complete, sets the second completion information, which indicates that writing of the second management information is complete, on the second management block VMB. For example, in the example of FIG. 9, the management device 100, when writing of the second management information to the second management block VMB is complete, sets the flag to a value indicating that the writing is complete.

When VETB is set in the second management information, the management device 100 erases a virtual block indicated by the VETB in the second management information. Then, the management device 100 updates the VETB in the second management information. Note that erasure of the virtual block indicated by the VETB and update of the VETB in the second management information can be performed before the second management information is written to the second management block VMB.

The management device 100 manages the virtual blocks through the aforementioned process, for example. Note that the management of the virtual blocks by the management device 100 in accordance with this embodiment is not limited to the aforementioned example. For example, when the management device 100 writes the updated second management information to the second management block VMB while the second management block VMB already has second management information stored therein, the management device 100 can write difference information, which indicates the difference between the currently stored second management information and the second management information to be newly written, to the second management block VMB.

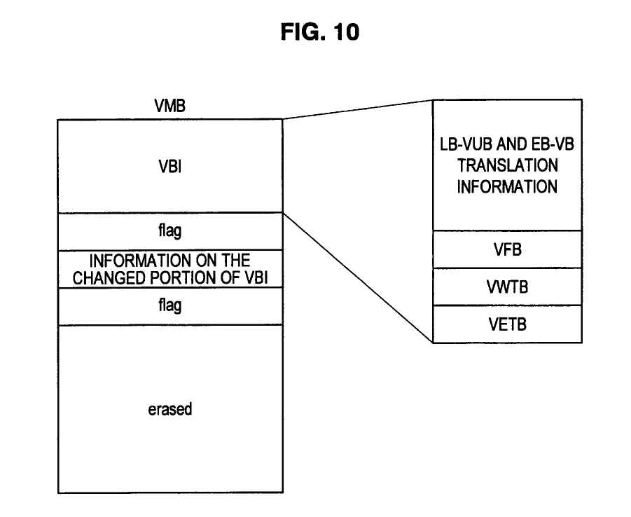

FIG. 10 is an explanatory diagram illustrating another example of the management of virtual blocks by the management device 100 in accordance with this embodiment. As shown in FIG. 10, the management device 100, in the aforementioned case, writes information about the changed portion (difference information) of the stored second management information and a flag, which indicates that writing of the information is complete, to the second management block VMB.

For example, when storing the second management information, it becomes possible to, not by storing the total information size of the second management information but by storing only the difference information into the second management block VMB as shown in FIG. 10, for example, reduce the written size of the second management information and the rewriting frequency of the nonvolatile memory. Thus, as the management device 100 can prolong the lifetime of the nonvolatile memory, it is also possible to prolong a period for which a memory system including the nonvolatile memory to be managed can be used. Further, by reducing the rewriting frequency of the nonvolatile memory, the management device 100 can suppress a decrease in performance of the nonvolatile memory such as a decrease in speed that could occur in execution of a rewriting process.

### (III) Example of the Management of Extended Blocks

Next, an example of the management of extended blocks in accordance with this embodiment will be described. The management device 100 writes as the third management information second translation information indicating the correspondence between the logical blocks LB and the cache blocks ECB and information indicating each of the cache blocks ECB, the write-back block EWBB, and the wear leveling block EWLB into the third management block EMB. Then, the management device 100 manages the virtual blocks using the third management information.

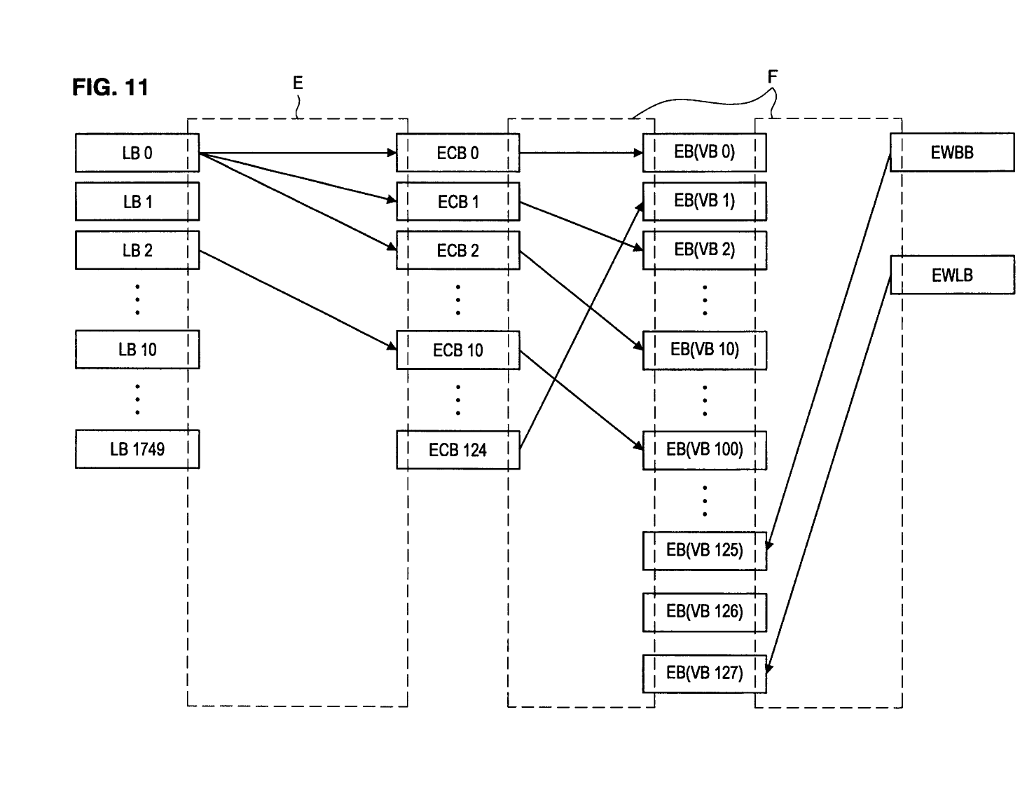

FIG. 11 is an explanatory diagram illustrating an example of the management of the extended blocks EB by the management device 100 in accordance with this embodiment.

The management device 100, using the third management information, manages the correspondence between the logical blocks LB and the cache blocks ECB as indicated by symbol E in FIG. 11, for example. In addition, the management device 100, using the third management information, manages which extended block each of the cache blocks ECB, the write-back block EWBB, and the wear leveling block EWLB corresponds to as indicated by symbol F in FIG. 11, for example.

The management device 100 can also divide, for example, each of the logical blocks LB and the cache blocks ECB in translation units and manage the logical blocks LB and the cache blocks ECB while associating them with each other in translation units. Herein, a translation unit in accordance with this embodiment is a unit that is greater than or equal to the minimum write size of the nonvolatile memory and is less than the virtual block size. The translation unit can be, for example, a unit that is an integer fraction of the block size and an integral multiple of the page size. Hereinafter, the translation unit of the logical block LB may also be referred to as “LTU” and the translation unit of the cache block ECB may also be referred to as “ECTU.”

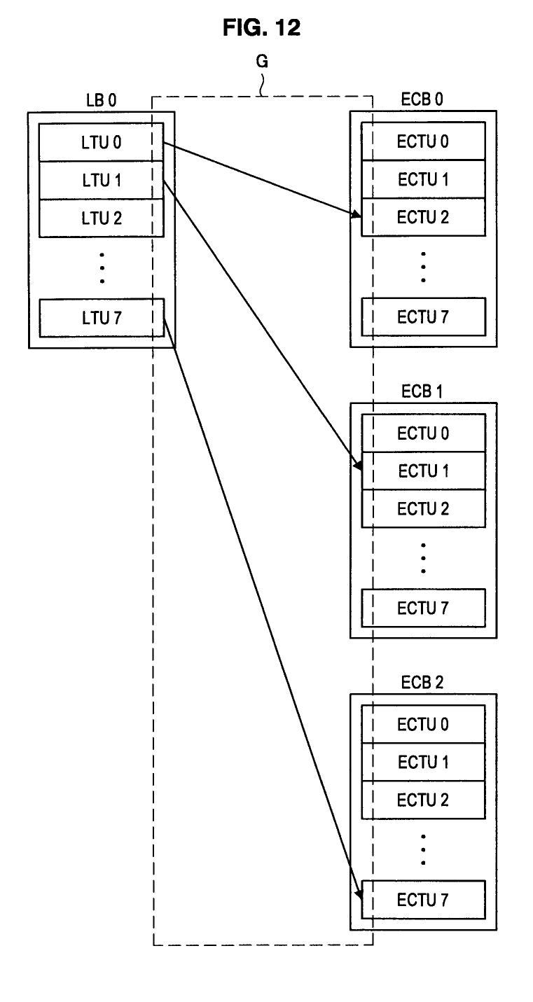

FIG. 12 is an explanatory diagram showing an example of associating translation units of a logical block LB with translation units of cache blocks ECB in accordance with this embodiment.

The management device 100 can associate each LTU with a given ECTU within an extended block ECB corresponding to the logical block LB, independently of the LTU number, as indicated by symbol G in FIG. 12, for example. In addition, the management device 100 writes as the third management information third translation information indicating the correspondence between each LTU in the logical block LB and the extended block ECB and the ECTU into the third management block EMB. Accordingly, the management device 100 can manage the logical block LB and the cache block ECB while associating them with each other in translation units.

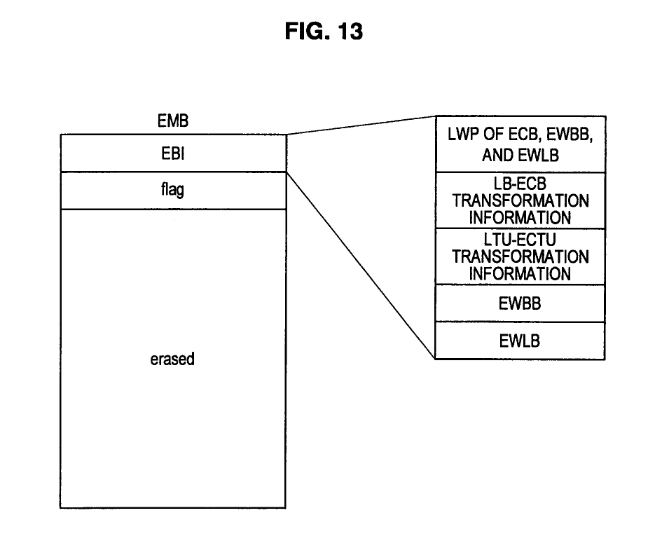

FIG. 13 is an explanatory diagram showing an example of the third management block EMB in the nonvolatile memory managed by the management device 100 in accordance with this embodiment. In FIG. 13, an example of the third management information in accordance with this embodiment is also shown.

In the third management block EMB, the third management information and third completion information indicating that writing of the third management information is complete are stored, for example. Although FIG. 13 shows an example in which the third completion information is a flag indicating if writing of the third management information is complete, it is needless to mention that the third completion information is not limited to the flag.

In addition, the third management information in accordance with this embodiment also includes the last written page address (hereinafter also referred to as “LWP”) of each of the extended blocks ECB, the write-back block EWBB, and the wear leveling block EWLB, translation information between the logical blocks LB and the extended blocks ECB, translation information between LTU and ECTU, information on the write-back block EWBB, and information on the wear leveling block EWLB.

Herein, the translation information between the logical blocks LB and the extended blocks ECB corresponds to the aforementioned second translation information. The translation information between the logical blocks LB and the extended blocks ECB can be, for example, a table in which the logical blocks LB are associated with the extended blocks ECB or information in which the addresses of the logical blocks LB are associated with the addresses of the extended blocks ECB. In addition, the translation information between LTU and ECTU corresponds to the aforementioned third translation information. The translation information between LTU and ECTU can be information in which the address of each LTU is associated with the address of the ECTU such as, for example, a table in which the LTU is associated with the ECTU (hereinafter also referred to as “LTU-ECTU table”). The information on the write-back block EWBB can be, for example, the address of the virtual block allocated as the write-back block EWBB. The information on the wear leveling block EWLB can be, for example, the address of the virtual block allocated as the wear leveling block EWLB.

The management device 100 can perform management of the LWP, management of the correspondence between the logical blocks LB and the extended blocks ECB, management of the correspondence between the LTU and the ECTU, management of the write-back block EWBB, and management of the wear leveling block EWLB by using the third management information with the structure shown in FIG. 13, for example. Note that the third management information in accordance with this embodiment is not limited to the structure shown in FIG. 13. For example, when the management device 100 does not have a configuration for managing the logical blocks LB and the cache blocks ECB while associating them with each other in translation units as shown in FIG. 12, for example, the third management information in accordance with this embodiment need not include the third translation information.

When the management device 100 has written data to each extended block EB in response to writing of user data, for example, the management device 100 updates the third management information. Then, the management device 100 writes the third management information to the third management block EMB. Further, the management device 100, when writing of the third management information to the third management block EMB is complete, sets the third completion information indicating that writing of the third management information is complete on the third management block EMB. In the example of FIG. 13, for example, the management device 100, when writing of the third management information to the third management block EMB is complete, sets the flag to a value indicating that the writing is complete.

Upon completion of the setting of the aforementioned third completion information on the third management block EMB, the management device 100 can further determine if the number of the cache blocks ECB being used (number used) has reached a predetermined number on the basis of the second translation information of the third management information, for example. Herein, the determination of if the number used has reached a predetermined number in accordance with this embodiment means, for example, a determination of if the number of the cache blocks ECB being used has become greater than or equal to a predetermined number, or a determination of if the number of the cache blocks ECB being used has exceeded a predetermined number. Then, the management device 100, upon determining that the number used has reached a predetermined number, performs a write-back process on the user data in the cache block ECB corresponding to the logical block LB with low update frequency.

Herein, the predetermined number used for the management device 100 to determine if the number of the cache blocks ECB being used has reached a predetermined number can be, for example, a preset number or a number set (or reset) on the basis of an operation signal corresponding to a user operation or an external operation signal.

Further, the management device 100, upon determining that the number used has reached a predetermined number, selects a cache block ECB corresponding to the logical block LB with low update frequency, that is, a cache block ECB to be subjected to a write-back process, using LRU control, for example. Note that the method of selecting a cache block ECB to be subjected to the write-back process in accordance with this embodiment is not limited to the method that uses LRU control. For example, the management device 100 can divide the user data to be written in units of a logical block, hold the number of writings performed in each logical block, and select a cache block ECB to be subjected to the write-back process on the basis of the number of writings. More specifically, the management device 100 selects a cache block ECB corresponding to the logical block whose number of writings performed in units of a logical block is the minimum as a cache block to be subjected to the write-back process.

By performing the write-back process as described above, the management device 100 can efficiently use the extended blocks ECB, and thus can reduce the rewriting frequency of the nonvolatile memory, for example. Thus, as the management device 100 can prolong the lifetime of the nonvolatile memory, it is also possible to prolong a period for which a memory system including the nonvolatile memory to be managed can be used. Further, by reducing the rewriting frequency of the nonvolatile memory, the management device 100 can suppress a decrease in performance of the nonvolatile memory such as a decrease in speed that could occur in execution of a rewriting process.

The management device 100 manages the extended blocks through the aforementioned process, for example. Note that the method of managing the extended blocks with the management device 100 in accordance with this embodiment is not limited to the aforementioned example.

[Specific Example of Process Related to the Management Method in Accordance with this Embodiment]

The management device 100 in accordance with this embodiment manages a nonvolatile memory in three stages including the management of physical blocks, the management of virtual blocks, and the management of extended blocks as described in (I) to (III) above, for example. Next, a specific example of a nonvolatile memory management method in accordance with this embodiment will be described.

(1) Process Performed at the Start of the Management (Process Performed when Nonvolatile Memory is Mounted)

The management device 100, when starting management of a nonvolatile memory, reads management information stored in the nonvolatile memory from the nonvolatile memory, and records the read management information on a recording medium. Then, the management device 100 manages the nonvolatile memory on the basis of the management information recorded on the recording medium. The recording medium herein can be, for example, a recording medium whose data write/read speed is faster than that of the nonvolatile memory, such as a RAM (Random Access Memory, not shown).

As described above, by recording (expanding) the management information on (in) a recording medium whose data write/read speed is faster than that of the nonvolatile memory at the start of the management, and by using the management information recorded on the recording medium, it becomes possible to further reduce the time until when the management is started. Herein, the time until when the management is started can also be understood as, for example, the time until when a memory system including the nonvolatile memory to be managed is booted. In addition, as the management device 100 can reduce the size of the management information in accordance with this embodiment than the size of the management information in accordance with the related art, the possibility that the expansion of the management information may stress the recording medium can be reduced even when the management information is expanded in the recording medium. Hereinafter, a case in which the nonvolatile memory is a RAM will be exemplarily described.

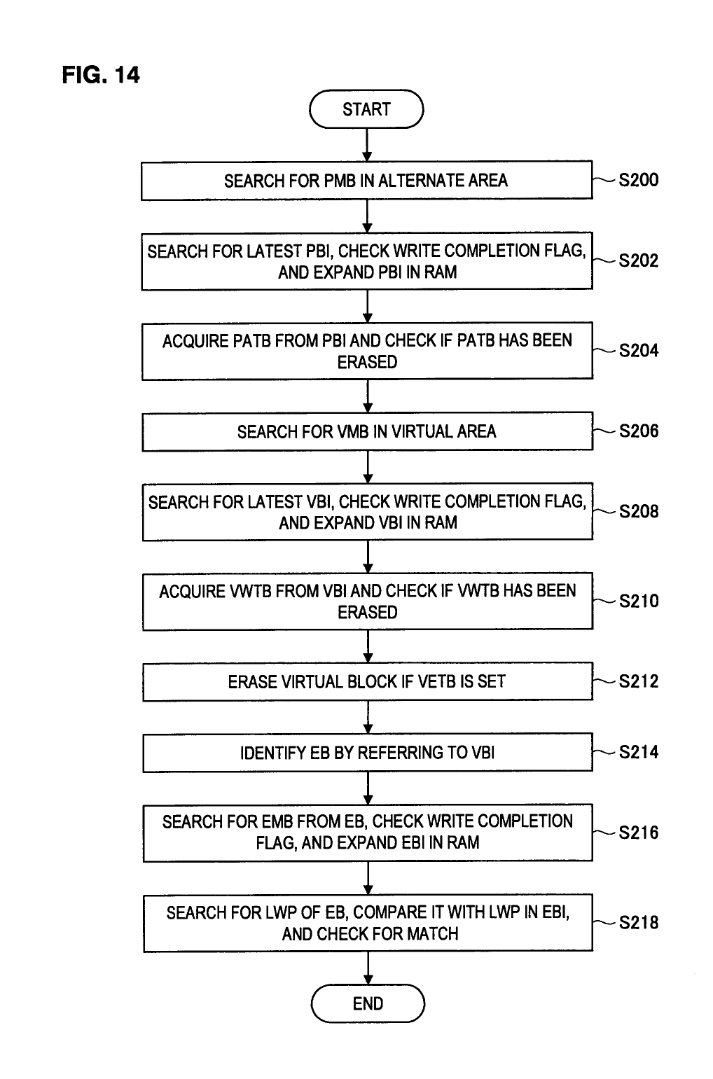

FIG. 14 is a flowchart showing an example of a process performed by the management device 100 in accordance with this embodiment at the start of the management of a nonvolatile memory. Herein, FIG. 14 shows an example of a process performed by the management device 100 when a nonvolatile memory is mounted.

The management device 100 searches for the first management area PMB in the alternate area A2 (S200). Then, the management device 100 searches for the latest first management information from the first management area PMB, checks the write completion flag, and expands the first management information in the RAM if the write completion flag indicates that writing is complete (S202).

Then, the management device 100 acquires PATB from the first management information, and checks if the PATB has been erased (S204).

Herein, the processes performed by the management device 100 in steps S200 to S204 correspond to the process of determining if the last written page in the first management block PMB is the first completion information and if the PATB in the first management information has been erased. Such determination also corresponds to a determination of a writing error on the basis of the read first management information. By determining a writing error on the basis of the first management information as described above, the management device 100 can detect generation of a writing error even when writing is interrupted or erasing is interrupted due to an unexpected event such as power interruption, for example.

Although not shown in FIG. 14, if it is determined that a writing error has been generated, the management device 100 invalidates the data being processed that corresponds to the interrupted writing or erasing, and restores the nonvolatile memory to a state before the process. Then, the management device 100 terminates the process shown in FIG. 14. As described above, by determining that writing has been interrupted or erasing has been interrupted due to an unexpected event such as power interruption, for example, and restoring the nonvolatile memory to a state before the process, the management device 100 can prevent generation of garbling of data of a part that was being written or erased when the unexpected event occurred.

Herein, the method of restoring the nonvolatile memory to a state before the process can be, for example, restoration with the use of the latest management information corresponding to the first completion information, the second completion information, and the third completion information each indicating that writing is complete in the management information. Note that it is needless to mention that the method of restoring the nonvolatile memory to a state before the process is not limited to such example.

After the process in step S204, the management device 100 searches for the second management block VMB in the virtual area A1 (S206). Then, the management device 100 searches for the latest second management information from the second management block VMB, checks the write completion flag, and expands the second management information in the RAM if the write completion flag indicates that writing is complete (S208).

Then, the management device 100 acquires VWTB from the second management information, and checks if the VWTB has been erased (S210).

Herein, the processes performed by the management device 100 in steps S206 to S210 correspond to the process of determining if the last written page in the second management block VMB is the second completion information and if the VWTB in the second management information has been erased. Such determination also corresponds to a determination of a writing error on the basis of the read second management information. By determining a writing error on the basis of the second management information as described above, the management device 100 can detect generation of a writing error even when writing is interrupted or erasing is interrupted due to an unexpected event such as power interruption, for example.

Although not shown in FIG. 14, if it is determined that a writing error has been generated, the management device 100 invalidates the data being processed that corresponds to the interrupted writing or erasing, and restores the nonvolatile memory to a state before the process. Then, the management device 100 terminates the process shown in FIG. 14.

After the process in step S210, the management device 100, if VETB is set on the second management information, erases a virtual block corresponding to the set VETB (S212), and identifies an extended block EB by referring to the second management information (S214).

The management device 100 searches for the latest third management information from the third management block EMB in the identified extended block EB, checks the write completion flag, and expands the third management information in the RAM if the write completion flag indicates that writing is complete (S216).

Then, the management device 100 searches for the LWP of the extended block EB, and compares the LWP of the extended block EB with the LWP of the third management information to check if they match (S218).

Herein, the processes performed by the management device 100 in steps S216 and S218 correspond to the process of determining if the last written page in the third management block EMB is the third completion information and if the state of the LWP of the last written page in the third management block EMB matches the state of the LWP of the extended block EB of the nonvolatile memory. Such determination also corresponds to a determination of a writing error on the basis of the read third management information and the last written page address of the extended block EB. By determining a writing error on the basis of the third management information and the last written page address of the extended block EB as described above, the management device 100 can detect generation of a writing error even when writing is interrupted or erasing is interrupted due to an unexpected event such as power interruption, for example.

Though not shown in FIG. 14, if it is determined that a writing error has been generated, the management device 100 invalidates the data being processed that corresponds to the interrupted writing or erasing, and restores the nonvolatile memory to a state before the process. Then, the management device 100 terminates the process shown in FIG. 14.

The management device 100 performs the process shown in FIG. 14 as a process at the start of the management, for example. Note that the process performed by the management device 100 in accordance with this embodiment at the start of the management is not limited to the process shown in FIG. 14. For example, the management device 100 can divide a plurality of physical blocks that constitute the nonvolatile memory into a plurality of virtual areas A1 and a plurality of alternate areas A2 corresponding to the virtual areas A1, and manage the nonvolatile memory using a plurality of pieces of second management information.

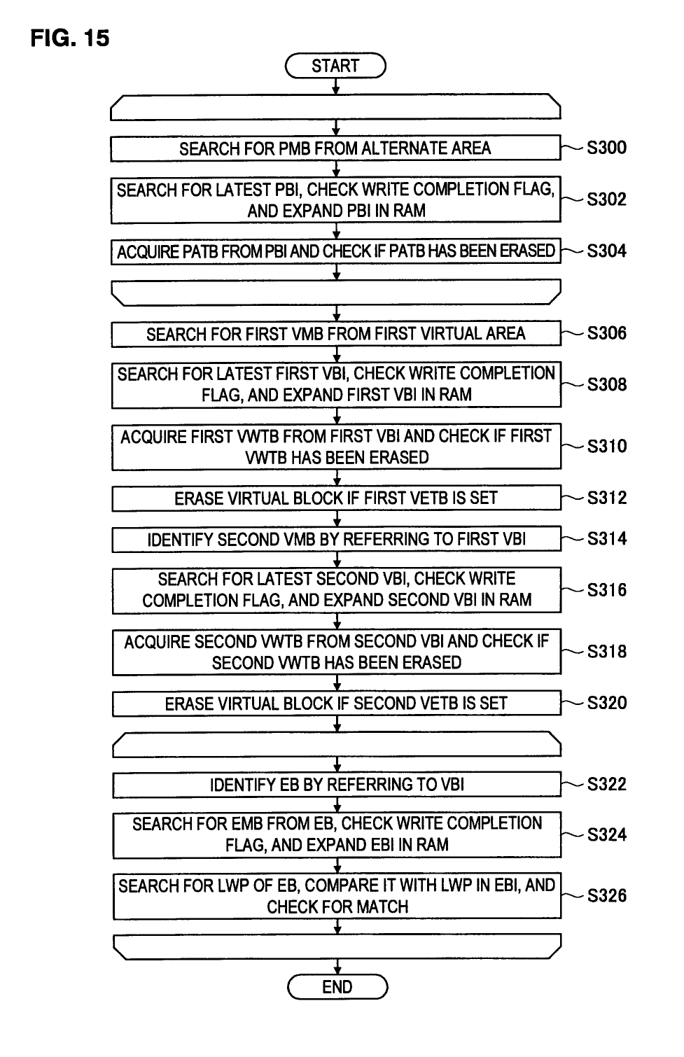

FIG. 15 is a flowchart showing another example of a process performed by the management device 100 in accordance with this embodiment at the start of the management of a nonvolatile memory. Herein, FIG. 15 shows an example of a process performed by the management device 100 when a nonvolatile memory is mounted in a case in which the management device 100 provides two virtual areas A1 and two alternate areas A2 in the nonvolatile memory and manages the nonvolatile memory using two pieces of second management information corresponding to the respective virtual areas A1. Hereinafter, second management information corresponding to the first virtual area A1 will be referred to as “first second management information” and second management information corresponding to the second virtual area A1 will be referred to as “second second management information.”

The management device 100 performs processes similar to those in steps S200 to S204 shown in FIG. 14 to each of the first alternate area A2 corresponding to the first virtual area A1 and the second alternate area A2 corresponding to the second virtual area A1 (S300 to S304). Note that although not shown in FIG. 15, if it is determined that a writing error has been generated, the management device 100 invalidates the data being processed that corresponds to the interrupted writing or erasing, and restores the nonvolatile memory to a state before the process, as in the process shown in FIG. 14, for example. Then, the management device 100 terminates the process shown in FIG. 15.

After the process in step S304, the management device 100 searches for the second management block VMB in the first virtual area A1 (S306). Then, the management device 100 searches for the latest first second management information from the second management block VMB in the first virtual area A1, checks the write completion flag, and expands the first second management information in the RAM if the write completion flag indicates that writing is complete (S308).

Then, the management device 100 acquires VWTB from the first second management information, and checks if the VWTB has been erased (S310).

Herein, the processes performed by the management device 100 in steps S306 to S310 correspond to the process of determining a writing error on the basis of the read first second management information as in steps S206 to S210 in FIG. 14. In addition, although not shown in FIG. 15, if it is determined that a writing error has been generated, the management device 100 invalidates the data being processed that corresponds to the interrupted writing or erasing, and restores the nonvolatile memory to a state before the process, as in the process shown in FIG. 14, for example. Then, the management device 100 terminates the process shown in FIG. 15.

After the process in step S310, the management device 100, if VETB is set on the first second management information, erases a virtual block corresponding to the set VETB (S312). Then, the management device 100, on the basis of information on the place where the second second management information corresponding to the second virtual area A2 is stored, recorded in the read first second management information, identifies a second management block VMB corresponding to the second second management information (S314).

As described above, the management device 100 identifies a second management block VMB corresponding to each of the other virtual areas A2 on the basis of information on the place where the second management information corresponding to each of the other virtual areas A2 is stored, recorded in the read first second management information. Accordingly, the management device 100 can manage the nonvolatile memory using a plurality of pieces of management information by reading the second management information corresponding to each of the other virtual areas A2. As described above, by searching for only a representative piece of the second management information (the first second management information in the example shown in FIG. 15) at the start of the management, it becomes possible to expand all pieces of the second management information to be used for the management in the RAM in a shorter time than when the plurality of pieces of second management information are individually searched for. Note that it is needless to mention that the management device 100 in accordance with this embodiment can also individually search for each of the plurality of pieces of second management information at the start of the management.

After the process in step S314, the management device 100 searches for the latest second second management information from the identified second management block VMB in the second alternate block A2, checks the write completion flag, and expands the second second management information in the RAM if the write completion flag indicates that writing is complete (S316).

Then, the management device 100 acquires VWTB from the second second management information, and checks if the VWTB has been erased (S318).

Herein, the processes performed by the management device 100 in steps S316 to S318 correspond to the process of determining a writing error on the basis of the read second second management information as in the processes of steps S206 to S210 in FIG. 14. In addition, although not shown in FIG. 15, if it is determined that a writing error has been generated, the management device 100 invalidates the data being processed that corresponds to the interrupted writing or erasing, and restores the nonvolatile memory to a state before the process, as in the process shown in FIG. 14, for example. Then, the management device 100 terminates the process shown in FIG. 15.

After the process in step S318, the management device 100, if VETB is set on the second second management information, erases a virtual block corresponding to the set VETB (S320).

The management device 100 performs processes similar to those in steps S214 to S218 shown in FIG. 14 to each of the first virtual area A1 and the second virtual area A1 (S322 to S326). Note that although not shown in FIG. 15, if it is determined that a writing error has been generated, the management device 100 invalidates the data being processed that corresponds to the interrupted writing or erasing, and restores the nonvolatile memory to a state before the process, as in the process shown in FIG. 14, for example. Then, the management device 100 terminates the process shown in FIG. 15.

The management device 100 performs the process shown in FIG. 15 as a process at the start of the management, for example, when the management device 100 divides a plurality of physical blocks PB that constitute a nonvolatile memory into a plurality of virtual areas A1 and a plurality of alternate areas A2 corresponding to the virtual areas A1, and manages the nonvolatile memory using a plurality of pieces of second management information.

The management device 100 performs the process shown in FIG. 14 or 15 as a process at the start of the management, for example. Note that it is needless to mention that the process performed by the management device 100 in accordance with this embodiment at the start of the management is not limited to the process shown in FIG. 14 or 15.

### (2) Writing Process

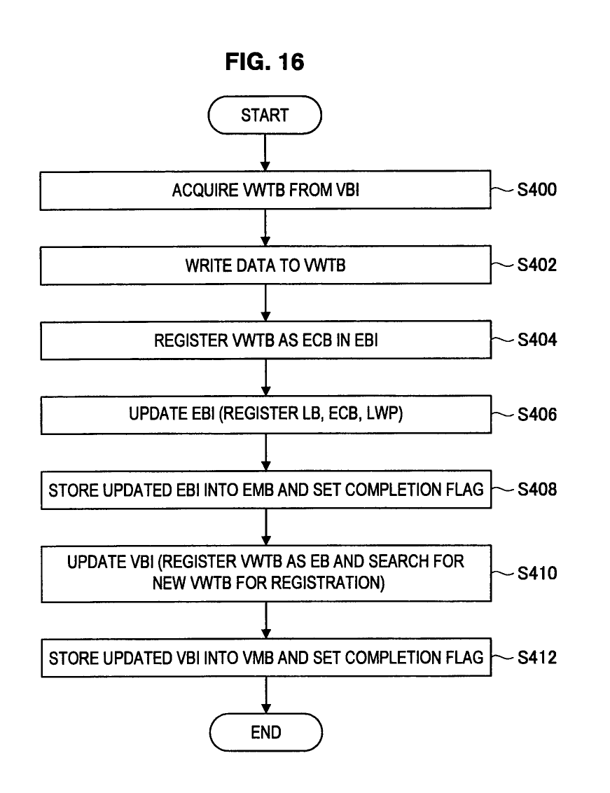

Next, an example of a writing process performed by the management device 100 in accordance with this embodiment will be described. FIG. 16 is a flowchart showing an example of a writing process performed by the management device 100 in accordance with this embodiment.

The management device 100 acquires VWTB from the second management information (S400), and writes data to a virtual block indicated by the VWTB (S402).

After the process in step S402, the management device 100 registers in the third management information the virtual block corresponding to the VWTB as a cache block ECB (S404), and updates the third management information (S406).

In addition, the management device 100 stores the updated third management information into the third management block EMB, and sets a completion flag (third completion information) indicating that the writing is complete (S408).

After the process in step S408, the management device 100 updates the second management information (S410), stores the updated second management information into the second management block VMB, and sets a completion flag (second completion information) indicating that the writing is complete (S412).

The management device 100 performs the process shown in FIG. 16, for example, as a writing process. Note that the writing process performed by the management device 100 in accordance with this embodiment is not limited to the process shown in FIG. 16.

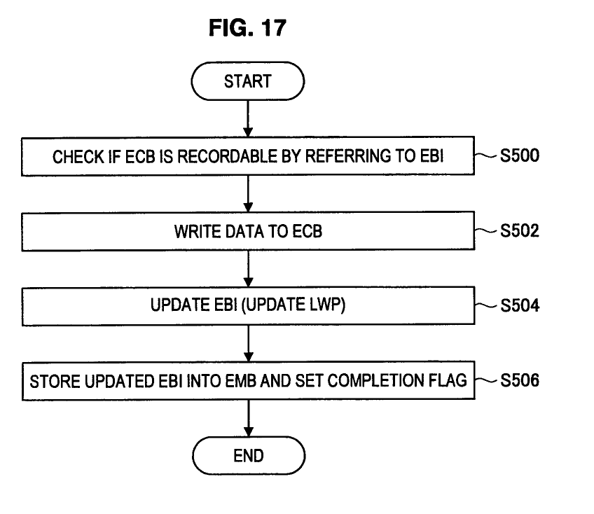

FIG. 17 is a flowchart showing another example of a writing process performed by the management device 100 in accordance with this embodiment. Herein, FIG. 17 shows an example of a process related to data writing to a cache block ECB performed by the management device 100.

The management device 100 refers to the third management information, and checks if the cache block ECB is recordable (S500).

If the cache block ECB is determined to be recordable in step S500, the management device 100 writes data to the determined cache block ECB (S502), and updates the third management information (S504). Then, the management device 100 stores the updated third management information into the third management block EMB, and sets a completion flag (third completion information) indicating that the writing is complete (S506).

The management device 100 performs the process shown in FIG. 17, for example, as a process related to data writing to a cache block ECB. Note that it is needless to mention that the writing process performed by the management device 100 in accordance with this embodiment is not limited to that shown in FIG. 16 or 17.

### (3) Write-Back Process

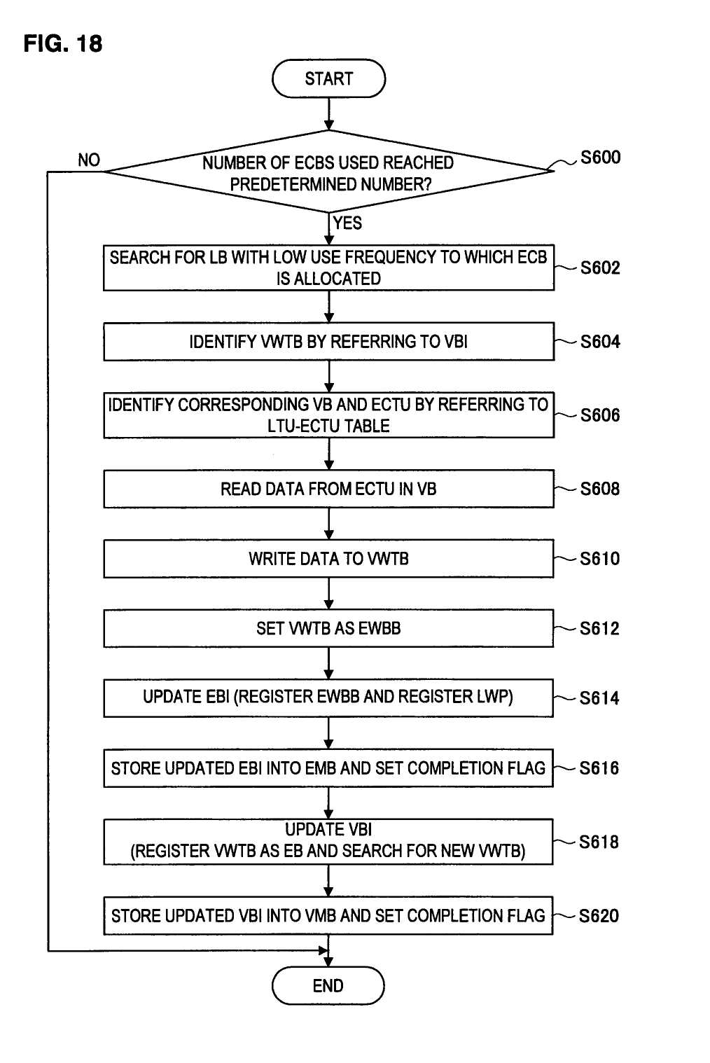

Next, an example of a write-back process performed by the management device 100 in accordance with this embodiment will be described. FIG. 18 is a flowchart showing an example of a write-back process performed by the management device 100 in accordance with this embodiment. Herein, FIG. 18 shows an example of a process related to the allocation of a new EWBB.

The management device 100 determines if the number of the cache blocks ECB being used has reached a predetermined number (S600). If it is not determined that the number of the cache blocks ECB being used has reached a predetermined number in step S600, the management device 100 terminates the write-back process.

If it is determined that the number of the cache blocks ECB being used has reached a predetermined number in step S600, the management device 100 searches for a logical block LB with low use frequency to which the cache block is allocated (S602). Herein, the management device 100 performs the process in step S602 by selecting a logical block LB with low use frequency using LRU control, for example, but the process in step S602 is not limited thereto.

The management device 100 identifies a virtual block corresponding to the VWTB by referring to the second management information (S604), and identifies a virtual block and ECTU corresponding to the logical block LB with low use frequency on the basis of the LTU-ECTU table (an example of the translation information between LTU and ECTU) of the third management information (S606).

After the process in step S606, the management device 100 reads data from the identified ECTU of the virtual block (S608), and writes the data to the VWTB identified in step S604 (S610).

After the process in step S610, the management device 100 sets the identified VWTB as the EWBB (S612), and updates the third management information (S614).

The management device 100 stores the updated third management information into the third management block EMB, and sets a completion flag (third completion information) indicating that the writing is complete (S616).

After the process in step S616, the management device 100 updates the second management information (S618), stores the updated second management information into the second management block VMB, and sets a completion flag (second completion information) indicating that the writing is complete (S620).

The management device 100 performs the process shown in FIG. 18, for example, as a process related to the allocation of EWBB. Note that the write-back process performed by the management device 100 in accordance with this embodiment is not limited to the process shown in FIG. 18.

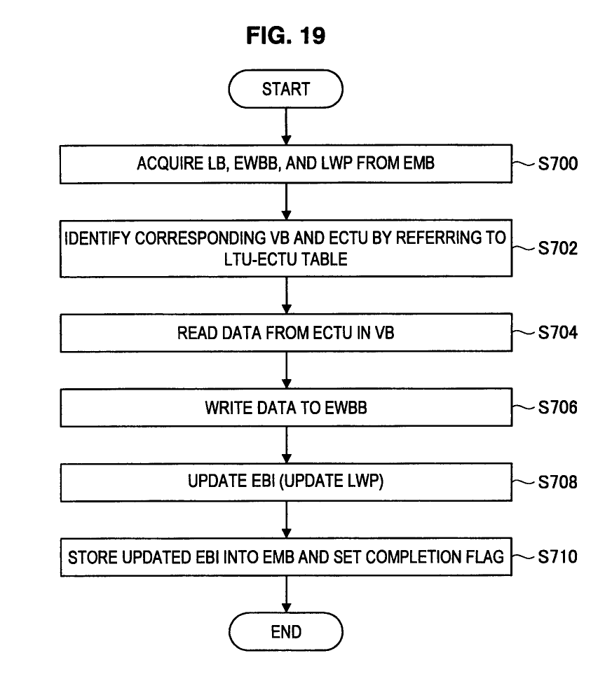

FIG. 19 is a flowchart showing another example of a write-back process performed by the management device 100 in accordance with this embodiment. Herein, FIG. 19 shows an example of a process of writing data to the allocated EWBB.

The management device 100 acquires a logical block LB, EWBB, and LWP from the third management block EMB (S700). After the process in step S700, the management device 100 identifies a virtual block and ECTU corresponding to the logical block acquired in step S700 on the basis of the LTU-ECTU table (an example of the translation information between LTU and ECTU) of the third management information (S702).

After the process in step S702, the management device 100 reads data from the identified ECTU of the virtual block (S704), and writes the data to the EWBB acquired in step S700 (S706).

After the process in step S706, the management device 100 updates the third management information (S708), stores the updated third management information into the third management block EMB, and sets a completion flag (third completion information) indicating that the writing is complete (S710).

The management device 100 performs the process shown in FIG. 19, for example, as a process of writing data to the allocated EWBB. Note that the write-back process performed by the management device 100 in accordance with this embodiment is not limited to the process shown in FIG. 18 or 19.

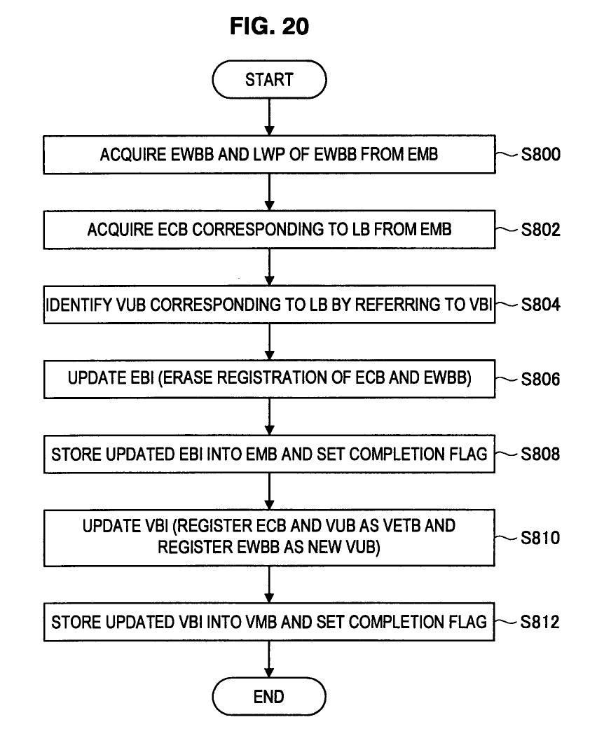

FIG. 20 is a flowchart showing still another example of a write-back process performed by the management device 100 in accordance with this embodiment. Herein, FIG. 20 shows an example of a process related to the completion of a write-back process.

The management device 100 acquires EWBB and LWP of the EWBB from the third management block EMB (S800), and acquires a cache block ECB corresponding to the logical block LB from the third management block EMB (S802). Herein, the processes in steps S800 and S802 are performed on the basis of the third management information shown in FIG. 13, for example.

After the process in step S802, the management device 100 identifies a user data block VUB corresponding to the logical block LB by referring to the second management information (S804).

After the process in step S804, the management device 100 updates the third management information (S806), stores the updated third management information into the third management block EMB, and sets a completion flag (third completion information) indicating that the writing is complete (S808).

After the process in step S808, the management device 100 updates the second management information (S810), stores the updated second management information into the second management block VMB, and sets a completion flag (second completion information) indicating that the writing is complete (S812).

The management device 100 performs the process shown in FIG. 20, for example, as a process related to the completion of a write-back process. Note that the write-back process in accordance with this embodiment is not limited to the process shown in FIG. 18, 19, or 20.

For example, the management device 100 can, as indicated by symbol G in FIG. 12, instead of associating each LTU with a given ECTU within an extended block ECB corresponding to the logical block LB independently of the LTU number, write user data to be written to the extended block EB in order of successive logical addresses. In such a case, the management device 100 can perform a process different from that shown in FIG. 18, 19, or 20, for example, as a write-back process.

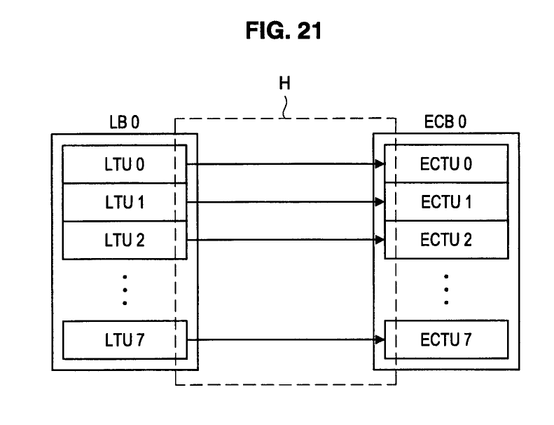

FIG. 21 is an explanatory diagram showing another example of associating translation units of a logical block LB with translation units of a cache block ECB in accordance with this embodiment. As indicated by symbol H in FIG. 21, by writing user data to be written to the extended block EB in order of successive logical addresses, it becomes possible for the management device 100 to perform a write-back process without copying data that would be performed in a typical write-back process. Thus, the management device 100 can suppress a decrease in performance of the nonvolatile memory such as a decrease in speed due to a write-back process, by performing a write-back process without copying data.

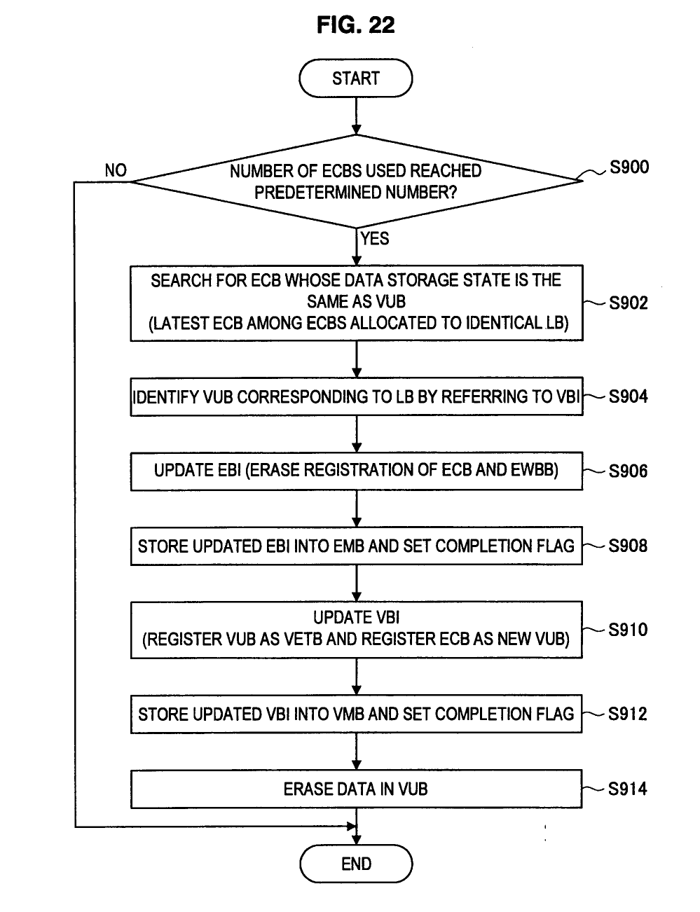

FIG. 22 is a flowchart showing another example of a write-back process performed by the management device 100 in accordance with this embodiment. Herein, FIG. 22 shows an example of a write-back process performed when user data to be written to the extended block EB are written in order of successive logical addresses as shown in FIG. 21, for example.

The management device 100 determines if the number of the cache blocks ECB being used has reached a predetermined number (S900). If it is not determined that the number of the cache blocks ECB being used has reached a predetermined number in step S900, the management device 100 terminates the write-back process.

If it is determined that the number of the cache blocks ECB being used has reached a predetermined number in step S900, the management device 100 searches for a cache block ECB whose data storage state is the same as that of the user data block VUB (S902). Herein, when a plurality of cache blocks ECB are allocated to a single logical block LB, for example, the management device 100 searches for the cache block ECB to which data was written most recently. In addition, although not shown in FIG. 22, when a cache block ECB whose data storage state is the same as that of the user data block VUB is not detected in step S902, the management device 100 performs a process from step S602 shown in FIG. 18, for example.

When a cache block ECB whose data storage state is the same as that of the user data block VUB is detected in step S902, the management device 100 identifies a user data block VUB corresponding to the logical block LB by referring to the second management information (S904).

After the process in step S904, the management device 100 updates the third management information (S908), stores the updated third management information into the third management block EMB, and sets a completion flag (third completion information) indicating that the writing is complete (S908).

Then, the management device 100 updates the second management information (S910), stores the updated second management information into the second management block VMB, and sets a completion flag (second completion flag) indicating that the writing is complete (S912).

After the process in step S912, the management device 100 erases data in the user data block VUB identified in step S904 (S914).

The management device 100 performs the process shown in FIG. 22, for example, as a write-back process when user data to be written to the extended block EB are written in order of successive logical addresses as shown in FIG. 21, for example.

### (4) Static Wear Leveling Process

The management device 100 can realize a static wear leveling process by performing a process similar to the write-back process described in (3) above, for example. Note that it is needless to mention that the static wear leveling process in accordance with this embodiment is not limited to the process similar to the write-back process described in (3) above.

### (5) Error Recovery Process

Next, an example of an error recovery process performed by the management device 100 in accordance with this embodiment will be described. Herein, the error recovery process in accordance with this embodiment is a process of recovering from an error when an error is generated during data writing to an extended block EB, for example.

When an error is generated while the management device 100 is writing data to an extended block EB, the management device 100 holds the data that had been written to the extended block EB in which the error was generated. In addition, the management device 100 continuously writes data to a corresponding virtual block on the basis of VWTB recorded in the second management information. Then, the management device 100 performs a write-back process using the data that had been written to the extended block EB in which the error was generated and the data continuously written to the virtual block. That is, the management device 100 performs a write-back process using a replacement process. By performing a write-back process using a replacement process as described above, the management device 100 can suppress a decrease in performance of the nonvolatile memory such as a decrease in speed that could occur when an error such as a program error is generated, for example.

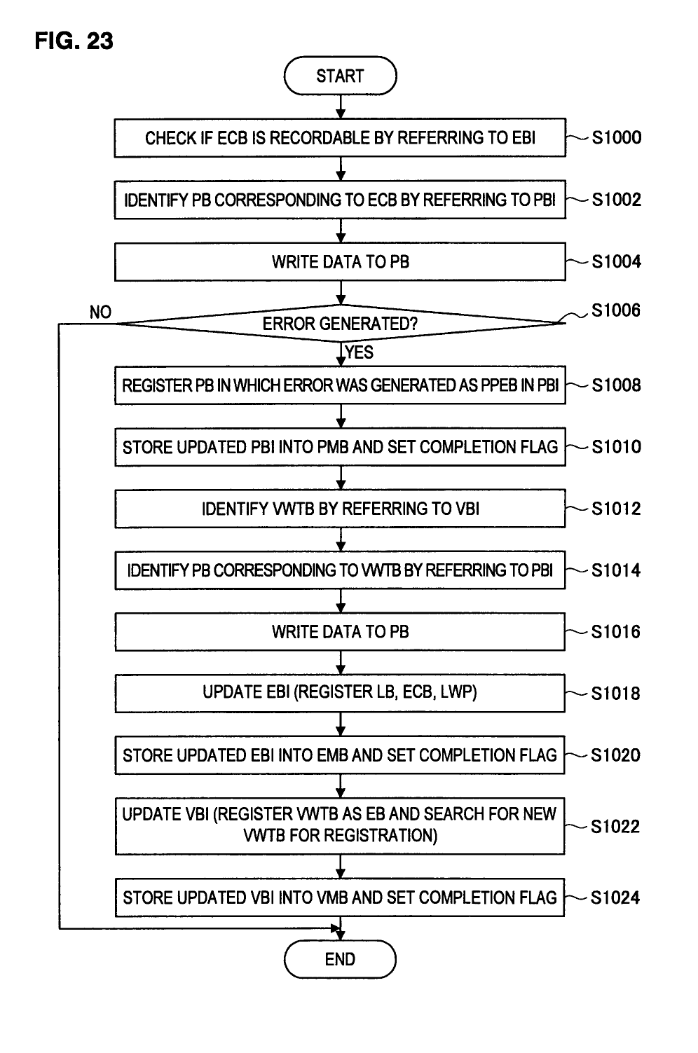

FIG. 23 is a flowchart showing an example of an error recovery process performed by the management device 100 in accordance with this embodiment. Herein, FIG. 23 shows an example of an error recovery process performed when an error is generated during writing.

The management device 100 checks if the cache block ECB is recordable by referring to the third management information (S1000). If it is determined that the cache block ECB is recordable in step S1000, the management device 100 identifies a physical block PB corresponding to the cache block ECB by referring to the first management information (S1002). Then, the management device 100 writes data to the identified physical block PB (S1004).

Once the data writing is started in step S1004, the management device 100 determines if an error was generated during the data writing in step S1004 (S1006). If it is not determined that an error was generated in step S1006, the management device 100 terminates the error recovery process.

If it is determined that an error was generated in step S1006, the management device 100 registers in the first management information the physical block PB in which the error was generated as the PPEB (S1008). Then, the management device 100 stores the updated first management information into the first management block PMB, and sets a completion flag (first completion information) indicating that the writing is complete (S1010).

After the process in step S1010, the management device 100 identifies a VWTB by referring to the second management information (S1012). Then, the management device 100 identifies a physical block PB corresponding to step S1012 by referring to the first management information (S1014). Then, the management device 100 writes data to the physical block PB identified in step S1014 (S1016).

After the process in step S1016, the management device 100 updates the third management information (S1018), stores the updated third management information into the third management block EMB, and sets a completion flag (third completion information) indicating that the writing is complete (S1020).

Then, the management device 100 updates the second management information (S1022), stores the updated second management information into the second management block VMB, and sets a completion flag (second completion information) indicating that the writing is complete (S1024).

The management device 100 performs the process shown in FIG. 23, for example, as an error recovery process performed when an error is generated during writing. Note that the error recovery process performed by the management device 100 in accordance with this embodiment is not limited to the process shown in FIG. 23.

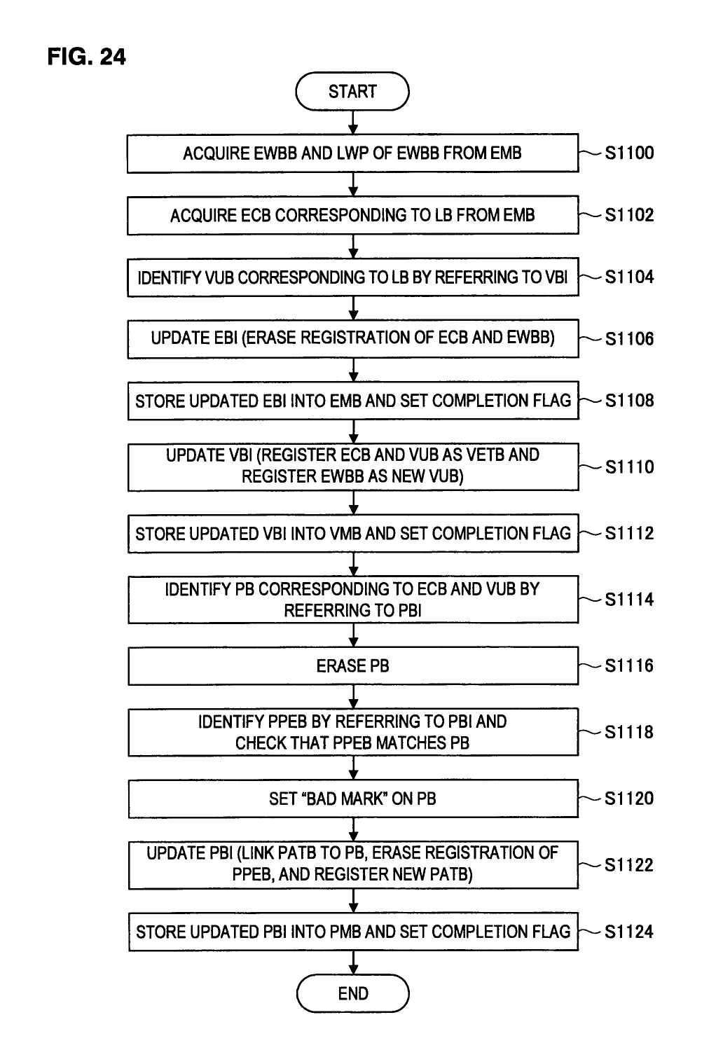

FIG. 24 is a flowchart showing another example of an error recovery process performed by the management device 100 in accordance with this embodiment. Herein, FIG. 24 shows an example of an error recovery process performed when an error is generated during the write-back process shown in FIG. 20.

The management device 100 acquires EWBB and LWP of the EWBB from the third management block EMB (S1100), and acquires a cache block ECB corresponding to the logical block LB from the third management block EMB (S1102). Herein, the processes in steps S1100 and S1102 are performed on the basis of the third management information shown in FIG. 13, for example.

After the process in step S1102, the management device 100 identifies a user data block VUB corresponding to the logical block LB by referring to the second management information (S1104).

After the process in step S1104, the management device 100 updates the third management information (S1106), stores the updated third management information into the third management block EMB, and sets a completion flag (third completion information) indicating that the writing is complete (S1108).

After the process in step S1108, the management device 100 updates the second management information (S1110), stores the updated second management information into the second management block VMB, and sets a completion flag (second completion information) indicating that the writing is complete (S1112).

After the process in step S1112, the management device 100 identifies a physical block PB corresponding to the cache block ECB and the user data block VUB by referring to the first management information (S1114). Then, the management device 100 erases the physical block PB identified in step S1114 (S1116).

After the process in step S1116, the management device 100 identifies a PPEB by referring to the first management information, and checks that the PPEB matches the physical block PB erased in step S1116 (S1118). When a match is confirmed in step S1118, the management device 100 sets “Bad Mark,” which indicates the physical block PB in which an error was generated, on the physical block PB erased in step S1116 (S1120).

After the process in step S1120, the management device 100 updates the first management information (S1112), stores the updated first management information into the first management block PMB, and sets a completion flag (first completion information) indicating that the writing is complete (S1124).

The management device 100 performs the process shown in FIG. 24, for example, as an error recovery process performed when an error is generated during the write-back process shown in FIG. 20.

The management device 100 performs the process shown in FIG. 23 or 24, for example, as an error recovery process. Note that it is needles to mention that the error recovery process performed by the management device 100 in accordance with this embodiment is not limited to the process shown in FIG. 23 or 24.

(Management Device in Accordance with this Embodiment)

Next, a configuration example of the management device 100 in accordance with this embodiment, which can perform a process related to the aforementioned management method in accordance with this embodiment, will be described.

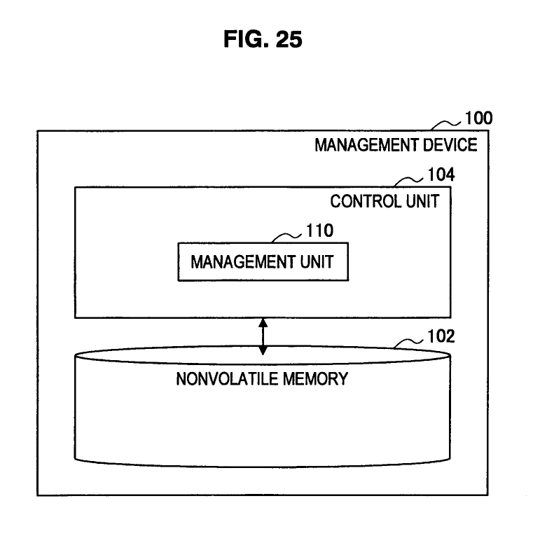

FIG. 25 is a block diagram showing a configuration example of the management device 100 in accordance with this embodiment. The management device 100 includes a nonvolatile memory 102 and a control unit 104, for example.

The management device 100 can also include a ROM (Read Only Memory, not shown), a RAM (not shown), an operation unit (not shown) operable by a user, a display unit (not shown) that displays various screens on a display screen, a communication unit (not shown) for communicating with an external device, and/or the like, for example. The management device 100 connects each of the aforementioned components via a bus as a data transmission channel, for example.

The ROM (not shown) stores control data such as programs and operation parameters used by the control unit 104. The RAM (not shown) temporarily stores programs executed by the control unit 104, management information, and the like. The operation unit (not shown) can be, for example, an operation device described below, and the display unit (not shown) can be, for example, a display device described below. The communication unit (not shown) can be, for example, a communication interface described below.

### [Hardware Configuration Example of the Management Device 100]

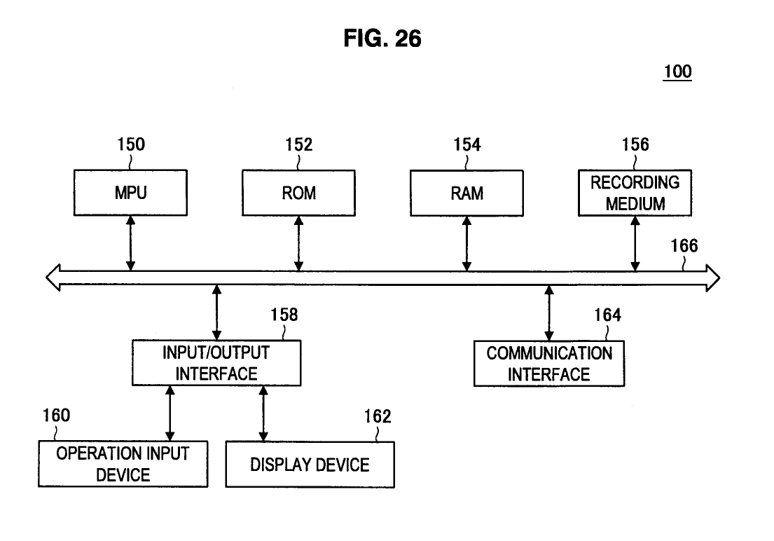

FIG. 26 is an explanatory diagram showing an example of the hardware configuration of the management device 100 in accordance with this embodiment. Referring to FIG. 26, the management device 100 includes, for example, a MPU 150, a ROM 152, a RAM 154, a recording medium 156, an input/output interface 158, an operation input device 160, a display device 162, and a communication interface 164. In addition, the management device 100 connects each component via a bus 166 as a data transmission channel, for example.

The MPU 150 includes a MPU (Micro Processing Unit), an integrated circuit obtained by integrating various circuits for implementing various functions such as control functions, and the like, and functions as the control unit 104 that controls the entire management device 100. In addition, the MPU 150 can also function as a management unit 110 described below in the management device 100.

The ROM 152 stores control data such as programs and operation parameters used by the MPU 150. The RAM 154 temporarily stores programs executed by the MPU 150, control information, and the like, for example. Herein, the RAM 154 corresponds to, for example, a recording medium whose data write/read speed is faster than that of the nonvolatile memory 102.

The recording medium 156 is a storage means in the management device 100, and functions as the nonvolatile memory 102. The recording medium 156 stores an application, various data, and the like, for example. Herein, the recording medium 156 can be, for example, a flash memory. The recording medium 156 can be detachable from the management device 100.

The input/output interface 158 connects the operation input device 160 and the display device 162, for example. The operation input device 160 functions as an operation unit (not shown), and the display device 162 functions as a display unit (not shown). Herein, the input/output interface 158 can be, for example, a USB (Universal Serial Bus) terminal, a DVI (Digital Visual Interface) terminal, an HDMI (High-Definition Multimedia Interface) terminal, or various processing circuits. The operation input device 160 is provided on the management device 100, for example, and is connected to the input/output interface 158 in the management device 100. The operation input device 160 can be, for example, a rotary selector such as a button, a direction key, or a jog dial; or a combination of them. The display device 162 is provided on the management device 100, for example, and is connected to the input/output interface 158 in the management device 100. The display device 162 can be, for example, a liquid crystal display (LCD) or an organic EL display (also referred to as an organic ElectroLuminescence display or an OLED display (Organic Light Emitting Diode display)). Note that it is needless to mention that the input/output interface 158 can be connected to an operation input device (e.g., a keyboard or a mouse) or a display device (e.g., an external display) as an external device of the management device 100. In addition, the display device 162 can be a device capable of displaying information and receiving user operations such as, for example, a touch screen.

The communication interface 164 is a communication means of the management device 100, and functions as a communication unit (not shown) for performing wireless/wire communication with an external device via a network (or directly). Herein, the communication interface 164 can be, for example, a communication antenna, an RF (Radio Frequency) circuit (wireless communication), a LAN terminal, or a transmission/reception circuit (wire communication). Note that the communication interface 164 in accordance with this embodiment is not limited to the aforementioned example, and can have a configuration supporting a network.

The management device 100 performs a process related to the aforementioned management method in accordance with this embodiment with the configuration shown in FIG. 26, for example. Note that the hardware configuration of the management device 100 in accordance with this embodiment is not limited to the configuration shown in FIG. 26. For example, the management device 100 can be an IC (Integrated Circuit) for implementing a function of performing a process related to the management method in accordance with this embodiment (e.g., a function of the management unit 110 described below). When such a configuration is used, the management device 100 controls, for example, an external nonvolatile memory as a nonvolatile memory to be controlled.

Referring again to FIG. 25, a configuration example of the management device 100 will be described. The nonvolatile memory 102 is a storage means of the management device 100. Herein, the nonvolatile memory 102 can be, for example, a flash memory. Data writing, reading, and erasing to/from the nonvolatile memory 102 are managed by the control unit 104 (more specifically, the management unit 110 described below).

The control unit 104 includes a MPU, for example, and has a function of controlling the entire management device 100. In addition, the control unit 104 includes the management unit 110 and plays a leading role in performing a process related to the management method in accordance with this embodiment.

The management unit 110 plays a leading role in performing a process related to the management method in accordance with this embodiment such as a process related to the management of physical blocks described in (I) above, a process related to the management of virtual blocks described in (II) above, and a process related to the management of extended blocks described in (III) above. Note that the management unit 110 can also include a first management unit (not shown) that plays a leading role in managing physical blocks, a second management unit (not shown) that plays a leading role in managing virtual blocks, and a third management unit (not shown) that plays a leading role in managing extended blocks.

The control unit 104 can, by including the management unit 110, for example, implement a process related to the aforementioned management method in accordance with this embodiment. Accordingly, the management device 100 can, by including the control unit 104, manage a nonvolatile memory while prolonging the lifetime of the nonvolatile memory.

The management device 100 performs a process related to the aforementioned management method in accordance with this embodiment with the configuration shown in FIG. 25, for example. Thus, the management device 100 can manage a nonvolatile memory while prolonging the lifetime of the nonvolatile memory.

The configuration of the management device 100 in accordance with this embodiment is not limited to the configuration shown in FIG. 25. For example, the management device 100 in accordance with this embodiment can, instead of having the nonvolatile memory 102, have a configuration for managing data writing, reading, and erasing to/from a nonvolatile memory in an external device that is connected to the management device 100 via a wire or wirelessly. Even in such a configuration, the management device 100 in accordance with this embodiment can manage the nonvolatile memory in the external device while prolonging the lifetime of the nonvolatile memory.

The management device 100 can also manage a plurality of nonvolatile memories. When managing a plurality of nonvolatile memories, the management device 100 can use one, two, or more nonvolatile memories as a cache block(s) ECB and use one, two, or more nonvolatile memories as a user data block(s) VUB. Herein, it is supposed that the rewriting frequency of the cache block ECB is higher than that of the user data block VUB. Thus, in the aforementioned case, the nonvolatile memory used as the cache block ECB can be a nonvolatile memory whose write speed and number of rewritings are about equal to or greater than those of the nonvolatile memory used as the user data block VUB. That is, in the aforementioned case, the nonvolatile memory used as the cache block ECB can be, for example, either the same type of or a different type of nonvolatile memory used as the user data block VUB.

As described above, the management device 100 in accordance with this embodiment manages a nonvolatile memory in a plurality of stages, for example, in management units of three stages including the management of physical blocks, the management of virtual blocks, and the management of extended blocks, and stores the management information of each management unit into the nonvolatile memory. When a nonvolatile memory is managed in a plurality of stages as described above, the size of the management information of each management unit used for the management in each stage in accordance with this embodiment can be smaller than the size of the management information in accordance with the related art. Thus, by storing the management information of each management unit into a nonvolatile memory, the management device 100 can reduce the written volume of the management information when storing it into the nonvolatile memory than in the related art. Further, the management device 100 can also manage the nonvolatile memory using the management information stored therein.

Thus, the management device 100 can manage a nonvolatile memory while prolonging the lifetime of the nonvolatile memory.

As the management device 100 can reduce the size of the management information than that in the related art, it is possible to reduce a decrease in performance that could occur when the management information is written using the related art.

Further, as the management device 100 manages a nonvolatile memory in a plurality of stages, for example, in management units of three stages including the management of physical blocks, the management of virtual blocks, and the management of extended blocks, it is possible to perform erasure efficiently. Thus, the management device 100 can avoid a decrease in performance of the nonvolatile memory that could occur in proportion to the erasure size units due to a decrease in speed during writing or a decrease in speed during restoration from a writing error, for example.

Although the management device 100 has been described above as this embodiment, this embodiment is not limited thereto. This embodiment can be applied to various devices such as, for example, a storage device using a nonvolatile memory, a computer such as a PC (Personal Computer) or a server, a display device such as a television receiver, a portable communication device such as a portable phone, a video/music reproducing device (or a video/music recording/reproducing device), or a game machine. Further, this embodiment can also be applied to, for example, control ICs of recording media incorporated in such various devices.

(Program in Accordance with this Embodiment)

Using a program (e.g., a program for implementing a process related to the management method in accordance with this embodiment or a program related to software that controls the management of a nonvolatile memory shown in FIG. 3) for causing a computer to function as the management device in accordance with this embodiment, it is possible to manage a nonvolatile memory while prolonging the lifetime of the nonvolatile memory.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

For example, although a program (a computer program) for causing a computer to function as the management device in accordance with this embodiment is described above, this embodiment can further provide a recording medium having the program stored therein.

The aforementioned configuration is an example of this embodiment. It is obvious that such a configuration is within the technical scope of the present disclosure.

The present disclosure contains subject matter related to that disclosed in Japanese Priority Patent Application JP 2011-032110 filed in the Japan Patent Office on Feb. 17, 2011, the entire content of which is hereby incorporated by reference.

What is claimed is:

1. A management device comprising a management unit that manages a nonvolatile memory, the nonvolatile memory being configured to allow data to be written, read, or erased electrically, allow writing and reading to be performed in units of a page, and allow erasing to be performed in units of a block including a plurality of pages, wherein the management unit:
divides a plurality of physical blocks that constitute the nonvolatile memory into a virtual area including virtual blocks corresponding to the physical blocks, and an alternate area including alternate blocks for replacing defective physical blocks among the physical blocks included in the virtual area,
manages the nonvolatile memory in management units of three stages including management of the physical blocks, management of the virtual blocks, and management of extended blocks, the extended blocks being physical blocks for temporarily storing user data among the physical blocks included in the virtual area, and
writes to the nonvolatile memory first management information for use in the management of the physical blocks, second management information for use in the management of the virtual blocks, and third management information for use in the management of the extended blocks.

2. The management device according to claim 1, wherein
the management unit, when the virtual area has a single defective physical block, associates a virtual block corresponding to the defective physical block with a single alternate block in the alternate area, and writes, as the first management information, information indicating correspondence between the virtual block and the alternate block to the nonvolatile memory, and
the management unit manages the physical blocks using the first management information.

3. The management device according to claim 2, wherein
the alternate area is divided into the alternate blocks and a first management block that is a physical block for storing the first management information, and
the management unit, when writing of the first management information to the first management block is complete, sets first completion information on the first management block, the first completion information indicating that writing of the first management information is complete.

4. The management device according to claim 2, wherein the management unit writes, as the first management information, information in which an address of the alternate block used is associated with an address of the virtual block corresponding to the alternate block, an address of the alternate block to be allocated the next time a defective block is generated, and an address of the replaced defective block.

5. The management device according to claim 1, wherein
the virtual area including the plurality of virtual blocks is divided into user data blocks that are physical blocks for storing user data, the extended blocks, free blocks that are physical blocks from which data has been erased, and a second management block that is a physical block for storing the second management information,
the management unit manages user data on the basis of logical blocks obtained by dividing an address space of the user data in units of a virtual block size,
the management unit writes, as the second management information, first translation information indicating correspondence between the logical blocks and the virtual blocks and information indicating the extended blocks to the second management block, and
the management unit manages the virtual blocks using the second management information.

6. The management device according to claim 5, wherein
the management unit writes, as the second management information, the first translation information, addresses of virtual blocks allocated as the extended blocks as the information indicating the extended blocks, addresses of the free blocks, an address of a virtual block to which data is written next, and an address of a virtual block to be erased,
the management unit, when writing of the second management information to the second management block is complete, sets second completion information on the second management block, the second completion information indicating that writing of the second management information is complete, and
the management unit, on the basis of the address of the virtual block to be erased in the second management information, erases the corresponding virtual block.

7. The management device according to claim 5, wherein when the management unit writes the second management information while the second management block already has the second management information stored therein, the management unit writes difference information to the second management block, the different information indicating a difference between the stored second management information and the second management information to be newly written.

8. The management device according to claim 5, wherein
the extended blocks are divided into cache blocks that are physical blocks for temporarily storing the user data before the user data are stored into the user data blocks, a first intermediate block that is an intermediate physical block for use in a write-back process that is a process of writing the user data stored in the cache block to the user data block, a second intermediate block that is an intermediate physical block for use in a static wear leveling process, and a third management block that is a physical block for storing the third management information,
the management unit writes, as the third management information, second translation information indicating correspondence between the logical blocks and the cache blocks and information indicating each of the cache blocks, the first intermediate block, and the second intermediate block to the third management block, and
the management unit manages the extended blocks using the third management information.

9. The management device according to claim 8, wherein
the management unit divides each of the logical blocks and the cache blocks in translation units each being greater than or equal to the minimum write size of the nonvolatile memory and being less than the virtual block size, and
the management unit further writes, as the third management information, third translation information indicating correspondence between the translation units of the logical blocks and the translation units of the cache blocks to the nonvolatile memory.

10. The management device according to claim 8, wherein
the management unit, when writing of the third management information to the third management block is complete, sets third completion information on the third management block, the third completion information indicating that the writing of the third management information is complete,
the management unit, on the basis of the second translation information of the third management information, determines if the number of the cache blocks being used has reached a predetermined number, and
the management unit, upon determining that the number of the cache blocks being used has reached a predetermined number, performs a write-back process on user data in a cache block corresponding to a logical block with low update frequency.

11. The management device according to claim 10, wherein the management unit:
selects a cache block to be subjected to the write-back process using LRU (Least Recently Used) control, or
divides user data to be written in units of a logical block, holds the number of writings performed in each logical block, and selects a cache block corresponding to a logical block whose number of writings performed in units of a logical block is the minimum as a cache block to be subjected to the write-back process.

12. The management device according to claim 8, wherein when an error is generated while the management unit is writing data to the extended block,
the management unit holds the data that had been written to the extended block in which the error was generated,
the management unit continuously writes data to a corresponding virtual block on the basis of information on the address of the virtual block to which data is written next, the information being recorded in the second management information, and
the management unit performs the write-back process using the data that had been written to the extended block in which the error was generated and the data continuously written to the virtual block.

13. The management device according to claim 5, wherein in the virtual area, the number of physical blocks that constitute the extended blocks is larger than the number of physical blocks that constitute the user data blocks.

14. The management device according to claim 8, wherein the management unit writes user data to be written to the extended block in order of successive logical addresses.

15. The management device according to claim 5, wherein
the management unit manages the plurality of physical blocks that constitute the nonvolatile memory by dividing the physical blocks into a plurality of virtual areas and a plurality of alternate areas corresponding to the virtual areas,
the management unit, when starting management of the nonvolatile memory, reads the second management information stored in a specific virtual area, and
the management unit, on the basis of information recorded in the read second management information, the information indicating a place where the second management information corresponding to each of the other virtual areas is stored, reads the second management information corresponding to each of the other virtual areas.

16. The management device according to claim 8, wherein when the management unit starts management of the nonvolatile memory,
the management unit reads the first management information, the second management information, and the third management information from the nonvolatile memory,
the management unit determines a writing error by performing each of a determination of a writing error on the basis of the read first management information, a determination of a writing error on the basis of the read second management information, and a determination of a writing error on the basis of the read third management information and a last written page address in the extended block, and
the management unit, upon determining that a writing error has been generated, invalidates the data being processed that corresponds to interrupted writing or erasing, and restores the nonvolatile memory to a state before the process.

17. The management device according to claim 1, wherein
the management unit, when managing a single nonvolatile memory, associates a single virtual block with a plurality of physical blocks, and
the management unit, when managing the same type of a plurality of nonvolatile memories, associates a single virtual block with corresponding physical blocks in the respective nonvolatile memories.

18. The management device according to claim 1, further comprising a recording medium to/from which data can be written and read at a faster speed than to/from the nonvolatile memory, wherein
the management unit, when starting management of the nonvolatile memory, reads the management information stored in the nonvolatile memory from the nonvolatile memory, and records the read management information on the recording medium, and
the management unit manages the nonvolatile memory on the basis of the management information recorded on the recording medium.

19. The management device according to claim 1, further comprising the nonvolatile memory.

20. A management method comprising managing a nonvolatile memory, the nonvolatile memory being configured to allow data to be written, read, or erased electrically, allow writing and reading to be performed in units of a page, and allow erasing to be performed in units of a block including a plurality of pages, wherein the managing step includes
dividing a plurality of physical blocks that constitute the nonvolatile memory into a virtual area including virtual blocks corresponding to the physical blocks, and an alternate area including alternate blocks for replacing defective physical blocks among the physical blocks included in the virtual area,
managing the nonvolatile memory in management units of three stages including management of the physical blocks, management of the virtual blocks, and management of extended blocks, the extended blocks being physical blocks for temporarily storing user data among the physical blocks included in the virtual area, and
writing to the nonvolatile memory first management information for use in the management of the physical blocks, second management information for use in the management of the virtual blocks, and third management information for use in the management of the extended blocks.
